(19) United States
(12) Patent Application Publication
(10) Pub. No.: US 2008/0139317 A1
(43) Pub. Date: Jun. 12, 2008

(54) Electronic game

(76) Inventor: Humayun Sheikh, Cambridge (GB)

Correspondence Address: SCHWEGMAN, LUNDBERG & WOESSNER, P.A., P.O. BOX 2938, MINNEAPOLIS, MN, 55402, US

(21) Appl. No.: 11/635,378

(22) Filed: Dec. 7, 2006

(51) Int. Cl. A63F 13/00

(52) U.S. Cl. 463/42

(57) ABSTRACT

This invention is generally concerned with apparatus and methods for providing virtual environments, in particular for electronic games in which multiple players may interact in a virtual environment.

An electronic game in which multiple players interact in a virtual environment to buy and sell products to acquire points, said electronic game comprising: a game engine configured to publish contracts in said virtual environment and configured to enable a said player to acquire a said contract, said contract defining at least a set of tasks for a said player to complete, a said set of tasks defining a selection of products to acquire in said virtual environment, said products being virtual representations of real-world products from one or more real-world companies; wherein said players are allocated said points in response to successful completion of said tasks; and wherein said points are redeemable against real-world products from said one or more companies represented in said virtual environment of said game.

### FIELD OF THE INVENTION

This invention is generally concerned with apparatus and methods for providing virtual environments, in particular for electronic games in which multiple players may interact in a virtual environment.

### BACKGROUND TO THE INVENTION

Electronic games in which multiple players interact in a virtual environment are known. An example of such a game is Second Life, where players create virtual representations of themselves and interact with other players within a virtual environment. Players may buy and sell virtual property within the virtual environment in order to build a virtual existence within the virtual environment.

However, there is a need for new electronic games, in which products may be bought and sold within a virtual environment.

### SUMMARY OF THE INVENTION

According to the present invention, there is therefore provided an electronic game in which multiple players interact in a virtual environment to buy and sell products to acquire points, said electronic game comprising: a game engine configured to publish contracts in said virtual environment and configured to enable a said player to acquire a said contract, said contract defining at least a set of tasks for a said player to complete, a said set of tasks defining a selection of products to acquire in said virtual environment, said products being virtual representations of real-world products from one or more real-world companies; wherein said players are allocated said points in response to successful completion of said tasks; and wherein said points are redeemable against real-world products from said one or more companies represented in said virtual environment of said game.

The above electronic game uses contracts to set the players tasks within the virtual environment, which increases the playability of the game. Furthermore, the use of a points based system, in which the player is allocated points in response to successful completion of the tasks defined by the contract, increases the desirability of the game as the points are redeemable against real-world products outside of the virtual environment.

Preferably, the electronic game comprises an auction engine to provide a virtual auction environment to enable said players to buy and sell said products. Preferably, the electronic game comprises an auction engine to provide a virtual auction environment in which said contracts are published, and wherein said auction engine enables a said player to take part in a reverse auction to acquire a contract defining a said set of tasks. The use of a virtual auction environment enables players to trade their items in a familiar and exciting real-time environment. Furthermore, the use of an auction engine to provide a virtual auction environment to enable a player to acquire a contract increases the element of competition within the game; the player's bid for the contract may not always be successful.

Preferably the auction engine providing a virtual auction environment in which said contracts are published further comprises a tender arbitrator, said tender arbitrator determining whether to accept a bid placed by said player for said set of tasks based on at least the lowest bid placed by said player and an attribute of said player. Preferably the attributes of the player include player skill.

Preferably, the electronic game further comprises a market model, said market model monitoring product data in said virtual environment, said product data comprising at least product demand data, product supply data and product price data, said market model regulating one or both of supply and demand of said products in said virtual environment based on said product data. Preferably the Market Model regulates said supply of said products by instructing a virtual non-player character to sell one or more of said products in said virtual environment. Preferably the Market Model regulates said demand of said products by defining said selection of said products in said set of tasks responsive to said product data. The use of a market model enables the electronic game to control the virtual market. This control is useful in providing an anti-collusion mechanism, to prevent players colluding with one another to artificially increase or decrease the virtual value of a product against the interest of other players. The anti-collusion mechanism may be implemented by controlling the supply or demand of products. The supply of products may be influenced by selling one or more of the products in the virtual environment. The demand for the products may be influenced by increasing or decreasing the number of relevant products specified in the set of tasks.

Preferably, the electronic game comprising a market model further comprises a data store to store said product data and wherein said market model is coupled to a data pre-processor to cache said product data from said data store. The use of a data pre-processor may overcome the problem of data flow being restricted within the system. The data pre-processor acts as a cache for the Market Model, which frees data from the data store to other processes within the game.

Preferably, the electronic game is configured to set a maximum price at which said product may be sold within said virtual environment.

Preferably, the electronic game comprises at least one virtual character engine, said virtual character engine being configured to provide at least one virtual non-avatar character in said virtual environment such that said players may interact with said virtual non-avatar character.

Preferably the virtual character is a client that publishes contracts in the virtual environment. The client is an in-game character that rewards players with virtual credit for successful completion of the contracts. Preferably the client has a persona and the selection of products in the set of tasks published in the contracts by the client is dependent on the client's persona.

Preferably the virtual character is a virtual player, capable of buying and selling products in the virtual environment according to a set of rules. The use of virtual player characters enables the game to continue if the number of human players drops below a number of players that would ordinarily limit the playability of the game.

Preferably the virtual character may be a virtual merchant that controls the release of one or more of the products into the virtual environment. The virtual merchant is a non-player character. Preferably the virtual merchant controls the release of one or more of the products by selling said products into said virtual environment under the control of a market model, wherein the Market Model monitors product data in the virtual environment and the Market Model regulates one or both supply and demand of the products in the virtual environment based on the product data. The virtual merchant is therefore a virtual representation of the anti-collusion mechanism which increases the supply of products within the virtual environment.

Preferably the electronic game further comprises a contracts engine that generates contracts for the game engine in response to data from a market model. The Market Model monitors product data in the virtual environment and regulates one or both of supply and demand of the products in the virtual environment based on the product data. Preferably, the contracts engine defines a number and category of the products performing said set of tasks. Preferably the contracts engine defines at least one of a time said player has to fulfil said contract; a number of points awarded for completion of said contract; and a number of points deducted from said player for failure of said contract. As well as allocating parameters to the contracts, the contracts engine also forms part of an anti-collusion mechanism, wherein the demand of products within the virtual environment is influenced by the product selection forming part of the contract.

Preferably, completion of a task requires a said player to navigate through one or more screens of game-related information for performing a said task, and wherein a said screen includes electronic advertising material for at least one of said real-world products to which said tasks pertain.

The present invention also provides an electronic game, in which multiple players interact in a virtual environment to buy and sell products to acquire points, said electronic game comprising: a contract in said virtual environment, said contract being acquirable by a player, said contract defining at least a set of tasks for said player to complete, said set of tasks defining a selection of acquisitions including a product in said virtual environment, said product being virtual representations of a non-virtual product from one or more real-world companies; and a value related to said contract, wherein said players are allocated said value in response to successful completion of said contract tasks, and wherein said value is redeemable against real-world products from said one or more companies represented in said virtual environment of said electronic game.

The above electronic game uses contracts to set players tasks within the virtual environment, which increases the playability of the game. Furthermore attributing a value to the contract, which the players is awarded for successful completion of the contract, increases the desirability of the game, as the value is redeemable against real-world products outside of the virtual environment.

Preferably, the electronic game comprises an auction engine to provide a virtual auction environment to enable said players to buy and sell said products. Preferably, the electronic game comprises an auction engine to provide a virtual auction environment in which said contracts are published, and wherein said auction engine enables a said player to take part in a reverse auction to acquire a contract defining a said set of tasks. The use of a virtual auction environment enables players to trade their items in a familiar and exciting real-time environment. Furthermore, the use of an auction engine to provide a virtual auction environment to enable a player to acquire a contract increases the element of competition within the game; the player's bid for the contract may not always be successful.

The present invention further provides a player graphic user interface (GUI) for use with an electronic game in which players interact in a virtual environment to buy and sell products to acquire points, said graphic user interface comprising a set of web pages, said web pages being configured to enable a player of said game to: view published contracts in said virtual environment; acquire said contract; complete a said set of tasks; and view representations of real-world products from one or more real-world companies; and wherein a said contract defines at least a set of tasks for a said player to complete, said set of tasks defining a selection of said products to acquire in said virtual environment, said products being virtual representations of said real-world products; and wherein said web pages are further configured to enable a player of said game to redeem points allocated to a said player in response to successful completion of said tasks against real-world products from said one or more real-world companies represented in said virtual environment of said game.

Preferably, said web pages comprise one or more static content elements capable of displaying static content; one or more active content elements capable of displaying active content; and one or more timed update content elements capable of displaying timed update content.

Preferably, the static content remains fixed during a display time of the web page. Preferably, at least one of the active contents and timed update content is changeable during a display time of the web page.

Preferably, the active content is changeable in response to interaction local to or remote from said graphic user interface. Preferably the timed update content is changeable in response to an expiration of a period of time. Preferably, the static content, active content and timed update content comprise at least one of text, images and sounds.

Preferably, completion of a task requires a said player to navigate through one or more screens of game-related information displayed by said player GUI for performing a said task, and wherein a said screen includes electronic advertising material for at least one of said real-world products to which said task pertains.

The present invention also provides an electronic game server system in which multiple players interact in a virtual environment to buy and sell products to acquire points, said electronic game server system comprising: a market system module configured to provide a virtual environment in which said players buy and sell said products; and a contracts engine configured to publish contracts in said virtual environment, said contracts defining at least a set of tasks for said players to complete, said tasks defining a selection of products to acquire in said virtual environment, said products being virtual representations of real-world products from one or more real-world companies; wherein said players are allocated said points in return for successful completion of said tasks; and wherein said points are redeemable against real-world products from said one or more companies represented in said virtual environment of said game system.

Preferably the market system module is configured to provide a virtual auction environment to enable said players to buy and sell said products. Preferably, the market system module is configured to provide a virtual auction environment in which said contracts are published, and wherein said market system module enables a said player to take part in a reverse auction to acquire a contract defining a said set of tasks.

Preferably, the electronic game server system further comprises a market model module configured to monitor product data in said virtual environment, said product data comprising at least product demand data, product supply data and product price data, and configured to regulate one or both of supply and demand of said products in said virtual environment based on said product data.

Preferably the Market Model module regulates the demand for the products by regulating the selection of products in the set of tasks. Preferably, the Market Model module regulates the supply of the products by selling the products in the virtual environment. The Market Model module is useful as an anti-collusion mechanism in which the supply of and demand for the products in the virtual environment may be controlled.

Preferably, the electronic game server system comprising the Market Model module further comprises a data store to store said product data and wherein said Market Model module further comprises a data pre-processor to cache said product data from said data store. The use of a data pre-processor may overcome the problem of data flow being restricted within the system. The data pre-processor acts as a cache for the Market Model, which frees data from the data store to other processes within the game.

Preferably the electronic game server system comprising a Market Model module further comprises a client system module configured to receive task constraint data from said Market Model module, said task constraint data defining a plurality of said products to issue in said set of tasks, and wherein said client system module generates said contracts based on said task constraint data.

Preferably, the client system module provides a client character, said client character being a virtual non-avatar in-game character that publishes said contracts, said client character rewarding said player with virtual credit for successful completion of said contracts. Preferably, the client has a persona, wherein the selection of products in the sets of tasks published in the contract is dependent on the client's persona.

Preferably, the electronic game server system further comprises at least one virtual character module configured to provide at least one virtual non-avatar character in said virtual environment such that players may interact with said virtual non-avatar characters.

Preferably, the virtual non-avatar character is a virtual player being capable of buying and selling products in the virtual environment according to a set of rules.

Preferably the virtual non-avatar character is a virtual merchant being a non-player character that controls the release of one or more of the products in the virtual environment. Preferably, the virtual merchant controls the release of one or more of the products by selling one or more of the products in the virtual environment. A market model module is provided and configured to monitor product data in the virtual environment and also configured to regulate one or both of the supply and demand of said products in the virtual market based on the product data. The Market Model module controls the virtual merchant.

Preferably, the electronic game server system further comprises a player module providing each of said players with a graphical user interface to enable each of said players to interact in said virtual environment.

Preferably completion of a task requires a said player to navigate through one or more screens of game-related information for performing a said task, and wherein a said screen includes electronic advertising material for at least one of said real-world products to which said tasks pertain.

The present invention also provides a method of allocating points to players in a virtual environment, comprising: publishing contracts in said virtual environment to enable a said player to acquire a said contract, said contract defining at least a set of tasks for a said player to complete, a said set of tasks defining a selection of products to acquire in said virtual environment, said products being virtual representations of real-world products from one or more real-world companies; enabling said players to interact to buy and sell said products within said virtual environment; and allocating said points to said players in response to successful completion of said tasks; wherein said points are redeemable against real-world products from said one or more companies represented in said virtual environment.

Preferably said players buy and sell said products in a virtual auction environment. Preferably, said contracts are published in a virtual auction environment, and wherein said players take part in a reverse auction to acquire a contract defining a said set of tasks.

Preferably one or both of supply and demand of said products in said virtual environment is regulated.

Preferably, said completion of a task requires a said player to navigate through one or more screens of game-related information for performing a said task, and wherein a said screen includes electronic advertising material for at least one of said real-world products to which said tasks pertain.

The present invention further provides a carrier medium carrying computer program code to, when running, implement an electronic game in which multiple players interact in a virtual environment to buy and sell products to acquire points, said electronic game comprising: a game engine configured to publish contracts in said virtual environment and configured to enable a said player to acquire a said contract, said contract defining at least a set of tasks for a said player to complete, a said set of tasks defining a selection of products to acquire in said virtual environment, said products being virtual representations of real-world products from one or more real-world companies; wherein said players are allocated said points in response to successful completion of said tasks; and wherein said points are redeemable against real-world products from said one or more companies represented in said virtual environment of said game.

The present invention further provides a carrier medium carrying computer program code to, when running, implement a player graphic user interface (GUI) for use with an electronic game in which players interact in a virtual environment to buy and sell products to acquire points, said graphic user interface comprising a set of web pages, said web pages being configured to enable a player of said game to: view published contracts in said virtual environment; acquire said contract; complete a said set of tasks; and view representations of real-world products from one or more real-world companies; and wherein a said contract defines at least a set of tasks for a said player to complete, said set of tasks defining a selection of said products to acquire in said virtual environment, said products being virtual representations of said real-world products, and wherein said web pages are further configured to enable a player of said game to redeem points allocated to a said player in response to successful completion of said tasks against real-world products from said one or more real-world companies represented in said virtual environment of said game.

The present invention further provides a carrier medium carrying computer program code to, when running, implement an electronic game server system in which multiple players interact in a virtual environment to buy and sell products to acquire points, said electronic game server system comprising: a market system module configured to provide a virtual environment in which said players buy and sell said products; and a contracts engine configured to publish contracts in said virtual environment, said contracts defining at least a set of tasks for said players to complete, said tasks defining a selection of products to acquire in said virtual environment, said products being virtual representations of real-world products from one or more real-world companies; wherein said players are allocated said points in return for successful completion of said tasks; and wherein said points are redeemable against real-world products from said one or more companies represented in said virtual environment of said game system.

The present invention further provides a carrier medium carrying computer program code to, when running, implement a method of allocating points to players in a virtual environment, comprising: publishing contracts in said virtual environment to enable a said player to acquire a said contract, said contract defining at least a set of tasks for a said player to complete, a said set of tasks defining a selection of products to acquire in said virtual environment, said products being virtual representations of real-world products from one or more real-world companies; enabling said players to interact to buy and sell said products within said virtual environment; and allocating said points to said players in response to successful completion of said tasks; wherein said points are redeemable against real-world products from said one or more companies represented in said virtual environment.

The present invention further provides a market system for use with an electronic game in which multiple players interact in a virtual environment to buy and sell products to fulfil a contract to acquire points, said contract defining at least a set of tasks for a said player to complete, a said set of tasks defining a selection of products to acquire in said virtual environment, said products being virtual representations of real-world products from one or more real-world companies; said market system providing a virtual auction environment to enable said players to buy and sell said products. The use of a virtual auction environment enables the players to trade products in a familiar and exciting real-time environment.

The present invention further provides a market model for use with an electronic game in which multiple players interact to buy and sell products to fulfil a contract to acquire points, said contract defining at least a set of tasks for a said player to complete, a said set of tasks defining a selection of products to acquire in said virtual environment, said products being virtual representations of real-world products from one or more real-world companies; said market model monitoring product data in said virtual environment, and said market model regulating one or both of supply or demand of said products in said virtual environment based on said product data. The use of a market model enables an electronic game to implement anti-collusion mechanisms to prevent players colluding and artificially increasing or decreasing the virtual cost of products within the virtual environment.

The present invention further provides a client system for use with an electronic game in which multiple players interact in a virtual environment to buy and sell products to fulfil a contract to acquire points, said contract defining at least a set of tasks for a said player to complete, a said set of tasks defining a selection of products to acquire in said virtual environment, said products being virtual representations of real-world products from one or more real-world companies; said client system providing a client character that publishes said contract, said client character being a virtual non-avatar in-game character, said client rewarding said player with virtual credit for successful completion of said contracts.

The present invention further provides a virtual character module for use with an electronic game in which multiple players interact in a virtual environment to buy and sell products to fulfil a contract to acquire points, said contract defining at least a set of tasks for a said player to complete, a said set of tasks defining a selection of products to acquire in said virtual environment, said products being virtual representations of real-world products from one or more real-world companies; said virtual character module being configured to provide at least one virtual non-avatar character to said virtual environment.

Preferably the virtual non-avatar character is a virtual player being capable of buying and selling products in the virtual environment according to a set of rules. Preferably, the virtual non-avatar character is a virtual merchant being a non-player character that controls the release of one or more of the products in the virtual environment.

The present invention further provides an electronic game in which multiple players interact in a virtual environment to buy and sell products to acquire points, said electronic game comprising: a game engine configured to publish contracts in said virtual environment and configured to enable a said player to acquire a said contract, said contract defining at least a set of tasks for a said player to complete, a said set of tasks defining a selection of products to acquire in said virtual environment, said products being virtual representations of real-world products from one or more real-world companies; wherein said completion of a task requires a said player to navigate through one or more screens of game-related information for performing a said task, and wherein a said screen includes electronic advertising material for at least one of said real-world products to which said tasks pertain. The game engine of the electronic game guides the player through targeted electronic advertising material such that the player may complete the task, thus generating interest in an associated real-world product.

Preferably said points are redeemable against real-world products from said one or more companies represented in said virtual environment.

Preferably, the electronic game comprises an auction engine to provide a virtual auction environment to enable said players to buy and sell said products. Preferably, the electronic game comprises an auction engine to provide a virtual auction environment in which said contracts are published, and wherein said auction engine enables a said player to take part in a reverse auction to acquire a contract defining a said set of tasks. Preferably, the auction engine is further provided with a tender arbitrator, said tender arbitrator determining whether to accept a bid placed by said player for said set of tasks based on at least the lowest bid placed by said player and an attribute of said player.

The present invention further provides an electronic game in which multiple players can interact in a virtual environment to buy and sell real-world products, said game comprising: one or more electronic player characters able to trade with said products; one or more virtual trader characters able to trade with said products; a virtual electronic market wherein said player and virtual characters are able to interact to trade with said real-world products; and a control system comprising a market model to receive data from said virtual market for said real-world products and to control said virtual market such that one or both of supply and demand of said real-world products are regulated within said virtual market.

Preferably, the electronic game comprises a system to connect trading of said real-world products in said virtual market with real-world prices of said products; and a system to allow exchange of credit in said virtual market for a said real-world product.

Preferably the control system is configured to implement one or more anti-collusion measures to restrict said trading of said electronic player characters.

Preferably the anti-collusion measures include a price control mechanism in the virtual market. Preferably the price control mechanism comprises a price limit for a said real-world product in said virtual market based on a real-world price for said real-world product. Preferably the price control mechanism comprises a virtual merchant character to increase supply of a product, the price of which is to be controlled. The use of a price control mechanism enables an anti-collusion mechanism to be implemented to prevent players from colluding with one another to artificially influence the price of products in the virtual environment. Preferably, the supply is regulated by controlling availability of the real-world products in said virtual market.

Preferably, the electronic game comprises one or more client characters, said client characters issuing sets of tasks to one or both of said player characters and said virtual trader characters, a said set of tasks comprising one or more tasks, a said task comprising a requirement for a player or virtual trader character to acquire a specified real-world product in said virtual environment; and wherein said control system is configured to regulate said demand by controlling said issued sets of tasks. Preferably, the electronic game comprising one or more client characters further comprises a system to reward a said player or trader character in response to completion of a said task with one ore more of points, money for use in said virtual market, and an increased skill level. Preferably, the electronic game comprising one or more client characters comprises an auction system for a player or trainer to acquire a set of tasks.

Preferably, the virtual market comprises one or more auctions, a said auction comprising a system for a said player or trader character to select a set of said real-world products and to monitor and bid on one or all of said selected products using a single auction display.

The present invention further provides an electronic game in which multiple players can interact in a virtual environment to buy and sell real-world products, said game comprising: one or more electronic player characters able to trade with said products; one or more client characters, said client characters issuing sets of tasks to one or both of said player characters and said virtual trader characters, a said set of tasks comprising one or more tasks, a said task comprising a requirement for a player or virtual trader character to acquire a specified real-world product in said virtual environment; a virtual electronic market wherein said player characters are able to interact to trade with said real-world products; and a control system comprising a market model to receive data from said virtual market for said real-world products and to control said virtual market such that one or both of supply and demand of said real-world products are regulated within said virtual market, wherein said control system is configured to regulate said demand by controlling said issued sets of tasks.

Preferably the electronic game further comprises one or more virtual trader characters able to trade with the products. Preferably the virtual trader characters are indistinguishable from the player characters.

The above-described methods and apparatus may be implemented using processor control code such as conventional program code or code for setting up or controlling an ASIC (Application Specific Integrated Circuit) or FPGA (Field Programmable Gate Array). This processor control code may be provided on a carrier medium such as a hard or floppy disk, CD- or DVD-Rom, programmed memory such as read-only memory (Firmware), or on a data carrier such as an optical or electrical signal carrier. As the skilled person will appreciate, such code may be distributed between a plurality of coupled components in communication with one another, for example across a network.

The above-described electronic game may be accessed and played on a number of electronic platforms. Such platforms include, but are not limited to, computers (portable or otherwise), portable electronic devices (PDA, mobile telephone), the Internet, television (e.g. interactive services) etc.

### BRIEF DESCRIPTION OF THE DRAWINGS

FIG. 1 is a schematic representation of the electronic game;

FIG. 2 shows a system overview schematic of the electronic game

FIG. 3 shows a system diagram of data flow;

FIG. 4 shows a market system overview for the auction based market;

FIG. 5 shows a process flow chart of an auction process;

FIG. 6a shows a more detailed systems view of the client market;

FIG. 6b shows a functional map of the operation of the client market;

FIG. 7 shows a database structure of the game;

FIG. 8 shows a more detailed system overview schematic of the game;

FIG. 9 shows an example player Graphic User Interface;

FIGS. 10a and 10b show example player Head Up Displays;

FIG. 11 shows a time display of the player Graphic User Interface;

FIG. 12a shows the home page displaying client related data;

FIG. 12b shows an example graphic that is displayed to a player once in the client market;

FIG. 13a shows the home page displaying inventory data;

FIG. 13b shows an example graphic used to display the player's product inventory;

FIG. 14a shows the home page displaying auction catalogue data;

FIG. 14b shows a more detailed graphic of the auction environment;

FIG. 14c shows the centre panel of the auction page in greater detail;

FIG. 14d shows three situations during the lifetime of the auction page;

FIG. 14e shows a portion of the Graphic User Interface graphic that enables the player to take part in the auction;

FIG. 15 shows the home page displaying news content;

FIG. 16 shows an example screenshot for a scratch card game.

### DETAILED DESCRIPTION OF EMBODIMENTS

The electronic game according to the present invention turns the popular activity of trading items, for example as found on online auction sites, into a fun, addictive game. The game can be thought of as a self-contained closed economic system with thousands of players buying and selling virtual products in a virtual environment. Broadly speaking, the aim of the game is to make as much profit as possible through canny trading. The profit can be translated into a reward, which can be spent outside the game on real-world goods ranging from small items up to large prizes worth $100k+.

Players of the game assume a role of star traders. Each player has an in-game avatar character that represents their trader and, much like with a Role Playing Game (RPG), these avatars will be able to gain skills and traits (for example aggressiveness, negotiating, bargain hunting, increased inventory capacity etc.) as the game progresses. Such skills will aid the player in maximising their profits.

Driving the gameplay, and the economy, are player tasks in the form of contracts. Each contract defines at least a set of tasks for a player to complete. The set of tasks define a selection of products to acquire in the virtual environment, where the products are virtual representations of real-world products from one or more real-world companies. The contracts are published in the virtual environment by virtual client characters that are virtual characters willing to pay an amount of virtual money for completion of the contract. Furthermore, completed contracts are worth a reward value that can be traded in for real-world products. The value of the reward is dependent at least in part on the difficulty in obtaining the products forming part of the contract. A reward value may be reward points or other ratings of a player's completion of the contract tasks.

Each player starts the game with an amount of virtual credits (iDosh) and a number of products, typically three. The player stores his products in a virtual inventory. iDosh is an arbitrary monetary denomination for use in the game only. iDosh has no monetary value and cannot be bought or sold. The amount of iDosh a player has is an indication of the level of success of that player.

Clients publish the contracts in a virtual auction environment. Players then take part in a reverse auction to acquire a contract. Having acquired a contract, the player must buy and sell products in the virtual environment to obtain products to fulfil the client contract.

The completion of the contract may require a player to navigate through one or more screens of game-related information. The screens include electronic advertising material for at least one of the real-world products to which the contract pertains.

Products are bought and sold within a virtual auction environment. The virtual auctions are live events that allow players to trade their products in a familiar and exciting real-time environment.

Points are awarded for successful completion of a client contract (iPoints). iPoints can be traded in for real-world products and various prizes that can be chosen from an online catalogue of selected real-world products from a product database. Players can also bank unused iPoints over multiple games. Furthermore iPoints are also usable to purchase tickets to other games within the electronic game, for example a Jackpot game, or other minigames.

Additional bonus games are built into the fabric of the main trading game. The bonus games provide a trivial diversion, to reward the players who spend more time playing and to provide more ways of winning extra prizes.

The players may also take part in a tutorial game. Typically this is played before entering the virtual environment in order to ease new players into the game. The tutorial game is a simplified version of the main game. Players are allocated contracts instead of having to bid for them.

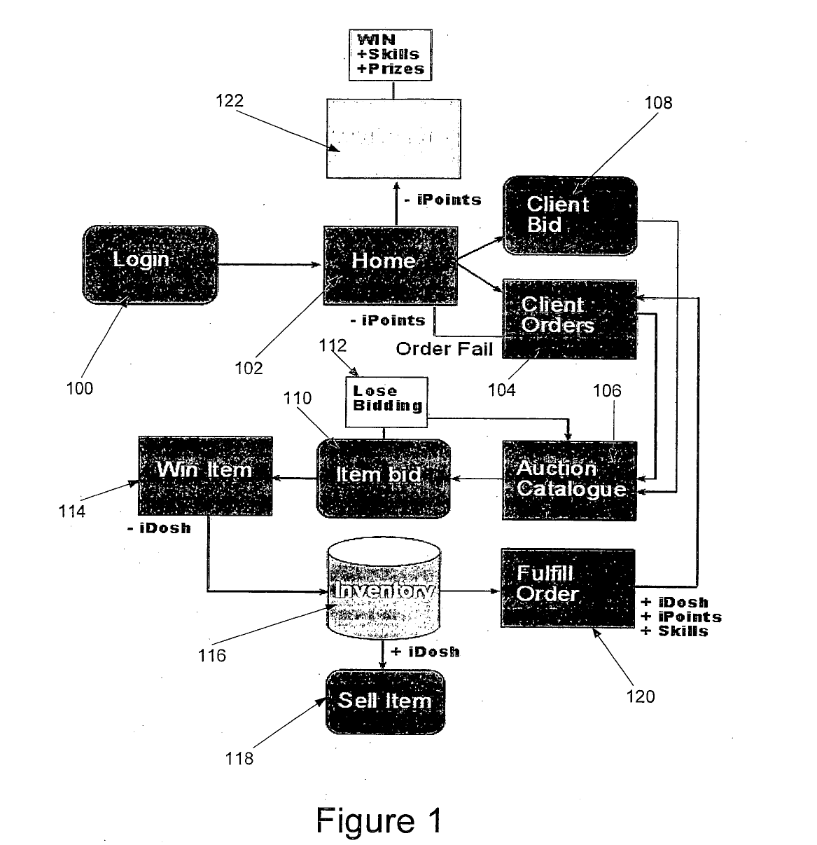

FIG. 1 is a schematic representation of the gameplay within the electronic game. The player logs into the game at 100 and is taken to a home page 102 in a graphic user interface. From the home 102 the player may play the main game or may be directed to one or more mini games 122. For the main game, the player bids for a client contract 108, which is generated in 104 and published in the auction catalogue 106. Once a contract has been acquired, the player may view products in the auction catalogue 106 and place bids on products 110. If the bid is unsuccessful 112 the player returns to the auction catalogue 106 and searches for another product matching the contract's requirement. A successful bid 114 results in the product being added to the player's inventory 116 and an amount of iDosh being removed from the player's amount of iDosh. Once the contract is fulfilled 120 the player is rewarded with iDosh, iPoints and additional skills levels. The player may also sell products 118 from his inventory, resulting in iDosh being credited to his amount of iDosh.

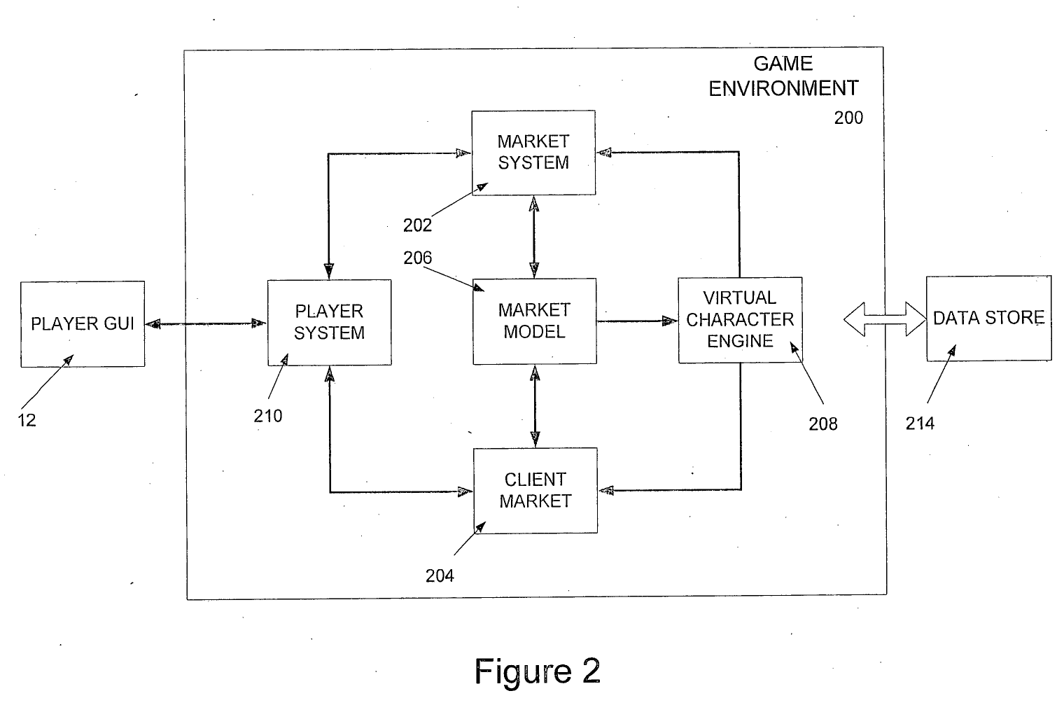

FIG. 2 shows a system overview schematic of the electronic game. A game environment 200 is provided with a number of subsystems or modules that provide various logical parts of the game. Within the game environment 200, there is a market system 202, a client market 204, a market model 206, a virtual character engine 208 and a player system 210. As shown in FIG. 2, a player Graphic User Interface (GUI) 212 resides out of the game environment 200. The subsystems or modules may reside on a single server within a network. Alternatively, each module may reside on separate servers across a network.

The market system 202 provides the virtual environment in which the players may buy and sell the products. As discussed above, buying and selling products takes place in a virtual auction environment. The Market Model 206 monitors product data within the market system 202. Product data includes, amongst others, product price data, product supply data and product demand data. Based on the monitored product data, the Market Model 206 may calculate the state of the virtual market and make predictions based on the product data.

The Client Market 204 provides a virtual environment in which the players and clients may interact. The client market 204 provides a mechanism for viewing contracts and placing contract bids. As discussed above, the contracts are published in a virtual auction environment and the players take part in a reverse auction to acquire the contracts. The Market Model 206 monitors data within the client market to determine the state of the virtual market.

A virtual character engine 208 is capable of providing virtual non-avatar characters to the market system 202 and the client market 204. The virtual non-avatar characters provided to the client market 204 are virtual clients which publish contracts in the virtual environment and reward players with virtual credit (iDosh) for successful completion of the contracts. The virtual non-avatar characters provided to the market system 202 are one or both of virtual players, that are capable of buying and selling products in the virtual environment to a set of rules, and virtual merchants, that control the release of one or more of the products into the virtual environment.

The Market Model 206 controls the virtual characters created by the virtual character engine 208 in response to the product data monitored in the market system 202 and the data monitored in the client market 204. In that way the Market Model 206 may maintain a stable virtual economic market. The Market Model 206 may also implement a number of anti-collusion mechanisms if the Market Model determines that the virtual price, supply or demand of the products in the virtual environment is being artificially increased or decreased by players within the virtual environment to the detriment of other players. Anti-collusion mechanisms and their implementations will be discussed below.

A player system 210 provides an interface between the player GUI 212 and the market system 202 and client market 204. The player system 210 enables the players to interact with other players in the market system 202 and client market 204.

The player GUI 212 provides a visual representation of the virtual environment and displays data relevant to the game to enable the player to acquire contracts, buy and sell products within the virtual environment and participate in other games related to the system.

A data store 214 is provided to store data for the game environment. The data stored in the data store 214 includes product related data, market system related data, client market data, player related data, and virtual character related data.

A problem associated with implementing a game environment as shown in FIG. 2 is that of data flow. One bottle-neck is between the data store and the Market Model.

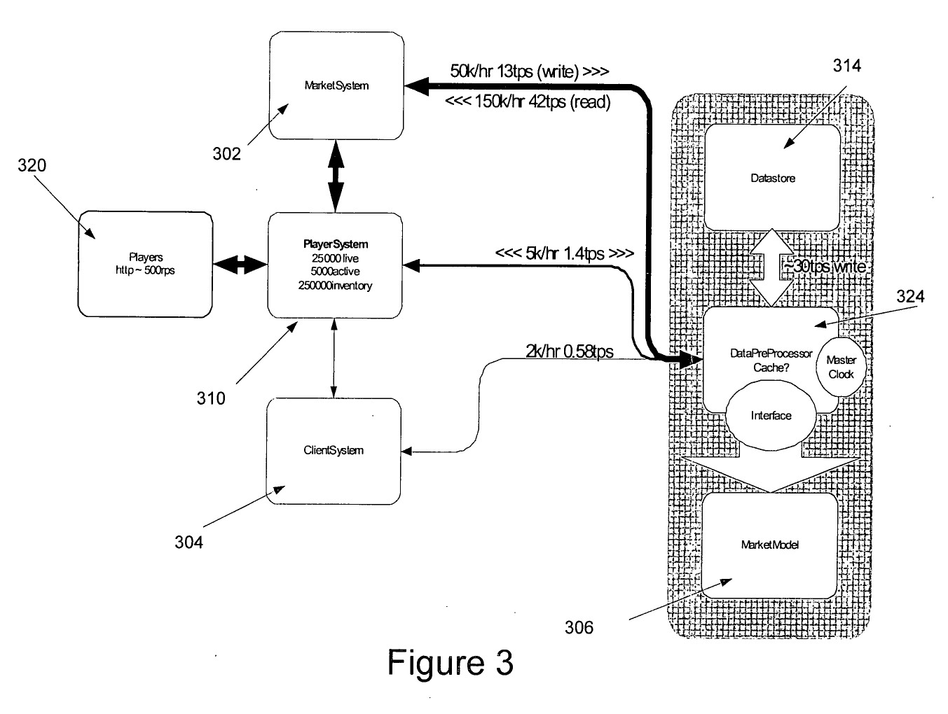

FIG. 3 shows a system that addresses the problem of data flow. A data pre-processor 324 is disposed between the data store and the Market Model 306. The data pre-processor acts as a cache for the Market Model 306. As such, other modules within the system, for example the market system, the player system and the client system may write to or read from the data store without causing unnecessary delays within the game environment.

We shall now describe the market system 202 in more detail. The market system 202 provides a virtual auction environment in which players can buy and sell products. The virtual auctions are similar to traditional ‘English auctions’ that are found in real-life auction houses. The virtual auction is called by a virtual auctioneer, who manages the bid increments and decides when the auction has ended.

The virtual auction has the following characteristics:
Virtual auctions are held at regular intervals, for example every ten minutes.
All lots are auctioned live, at the same time, as if there were multiple virtual auctioneers.
Players choose which product auctions they wish to follow and bid on.
Virtual auctions end when no more bids are made.

Preferably there are twelve virtual auction houses which start in turn every ten minutes and will last for ten minutes. This cycle preferably repeats every two hours.

The virtual auction rules are as follows:

### Listing and Item

1. Seller sets a reserve price (minimum selling price).
2. Seller picks an auction time or gets assigned the next available slot.
3. Seller pays a flat virtual fee to list an item.
4. The virtual auctioneer informs the seller that a maximum virtual value will automatically be set at some proportion above the average market price for the product.
5. The product is listed in the virtual auction catalogue before the auction takes place.
6. If the seller puts a product into a virtual auction house brochure and it is not sold within the virtual auction then the seller will have the option to place the product into the next virtual auction. The seller may select the option to roll over the product until it is sold, incurring a virtual commission on each entry to the virtual auction.
7. If the product is sold then the seller pays a sales virtual commission (percentage of virtual selling price) for the product.

### Auctioning Process

1. Players join a virtual auction and select which items from the virtual catalogue they wish to watch.
2. Bidding starts below the reserve price.
3. Players see what the next bid offer is and can choose to make it if they desire.
4. The virtual auctioneer increments the bid auction.
5. Bidding ends when no bids have been accepted for a predetermined amount of time or the maximum price has been reached.
6. The name of the player with the current winning bid is displayed next to each item in a Graphical User Interface.
7. A ten second timer, displayed next to each product, starts to count down to zero when only one bidder remains. Other players must bid within that time window if they want that product.
8. The item begins flashing within the last five seconds.
9. Currently held bid is highlighted.
10. Pressing a decline button removes the player's product from their bid window.
11. When a player has won the bid the product is removed from the window, funds are withdrawn from the player's account and the product enters their inventory.
12. If the reserve price is not met the product is not sold. The product within the buyer's list will state this after the bidding has stopped and the product will then return to the seller or be rolled over to the next virtual auction within that virtual auction house.
13. If the player does not have sufficient funds to bid, the Graphical User Interface prevents a bid from being placed.
14. If the buyer has chosen to bid on one or more identical products, these products will be shown separately within their bidding list.

If a player cannot be at the virtual auction then they may choose to make a ProxyBid. The player will enter the maximum price up to which they are willing to bid. The game will automatically bid up to this price within the virtual auction.

The live virtual auctions are held within virtual auction houses. Each house has its own catalogue, in which the sellers place their products and the buyers may browse and select the lots on which they wish to bid. Each virtual auction house has its own theme, which hints at the type of lot that the house specialises in. However, this does not restrict the sellers from placing any product in any virtual auction house. Example auction houses are as follows:
Luppers Auction House—Art and Fashion.
Manor House Auctioneers—Luxury Goods.
Bargain Hunters House—specialises in everything.
Diamond House—jewellery auction.
Fawkes Auctioneers—autos and other transport.
Elite Finest Auctioneers
Currells Quality Goods.

Each virtual auction has an associated catalogue. These catalogues are available to view from the submission of the first item up to the start of and during the virtual auction. Sellers submit their products to the catalogue up to a predetermined time before the virtual auction. During submission, the seller is asked to enter a reserve price. They are informed that the item will not climb over a set maximum value. Once submitted to one catalogue the product cannot be submitted to another catalogue until the first virtual auction is over.

The product is listed under a lot number with the name of the item and its guide price. The guide price is an average between the reserve price and the recommended retail price (RRP). If the seller has set no reserve price then the lot will show ‘no reserve set’ next to the product.

The buyer browses the lots within the catalogue; clicking on the lots within the GUI adds the lot to the player's bidding list on their buying page shown in the GUI.

The buyer may still select the lots during the virtual auction, but as the lots are sold, the lots will be marked as such within the catalogue and will not be selectable by the player.

Duplicated products will be grouped together and shown as one lot within the catalogue and show the amount to be auctioned. The guide price will be an average of all of the reserves and the recommended retail price.

Players are charged a virtual fee to list products in virtual auctions and for each sale made through the market system.

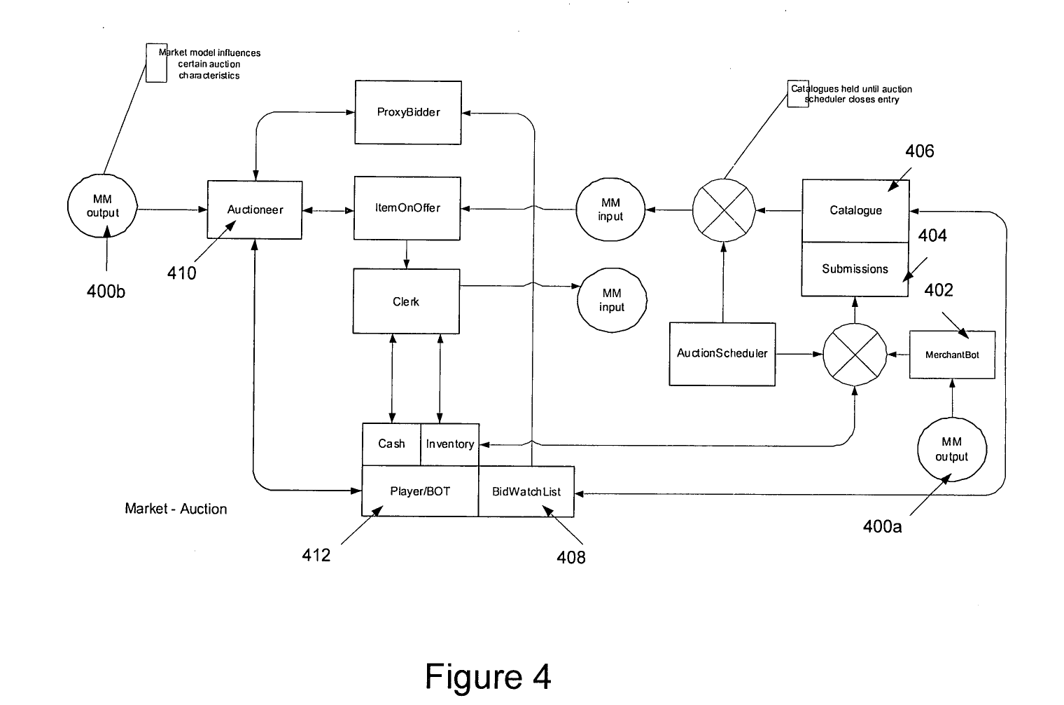

FIG. 4 shows a functional map of the auction based market system. Products presently unavailable in the virtual environment enter the environment via a virtual merchant character 402. The actual product being offered by the virtual merchant character is governed by the Market Model output 400a. The products are offered via a submission system 404. Submissions are possible until shortly before the auction is expected to start.

A player 412 can add products from their inventory for auction or, if required, withdraw products from an auction. As with the virtual merchant character, these actions can only happen up to shortly before the catalogue 406 is closed for submissions. A product marked for a given auction is held in ‘escrow’ and cannot be used for any other purpose.

A player 412 can, at any point, review the contents of the catalogue for a given current or future auction and elect to add, or remove, products of interest to their BidWatchList 408. A player may only remove an item from their BidWatchList if they are not the highest bidder and do not currently have a ProxyBid in place that could potentially make them a high bidder. A player 412 may submit a ProxyBid either before or during an auction. A bid will be accepted up until the point where the auctioneer 410 closes the sale.

Once the catalogue 406 is closed for submissions the make up of the catalogue is passed to the Market Model for analysis. The Market Model may return additional modifiers 400b that influence directly the way the auctioneer 410 works or the level of virtual credit charges applied to an auction.

During bidding, the auctioneer 410 accepts bids from players 412. On receipt of a bid from a player 412 the auctioneer 410 checks the bid value against any previously existing ProxyBids. If there is a ProxyBid of at least the same value then the ProxyBid is accepted as being older. If there are any previous bids at the same value then these are discarded and the player would be invited to bid again. The auctioneer 410 then closes the bidding at a pre-determined time and passes the details of the auction to a market clerk 414.

The market clerk 414 records the transactions and exchanges virtual credit and product between the buyer and seller. The market clerk 414 may charge a virtual commission to either buyer or seller according to decisions made by the Market Model. On completion of all products in an auction catalogue 406, the market clerk 414 passes the information to the Market Model for processing.

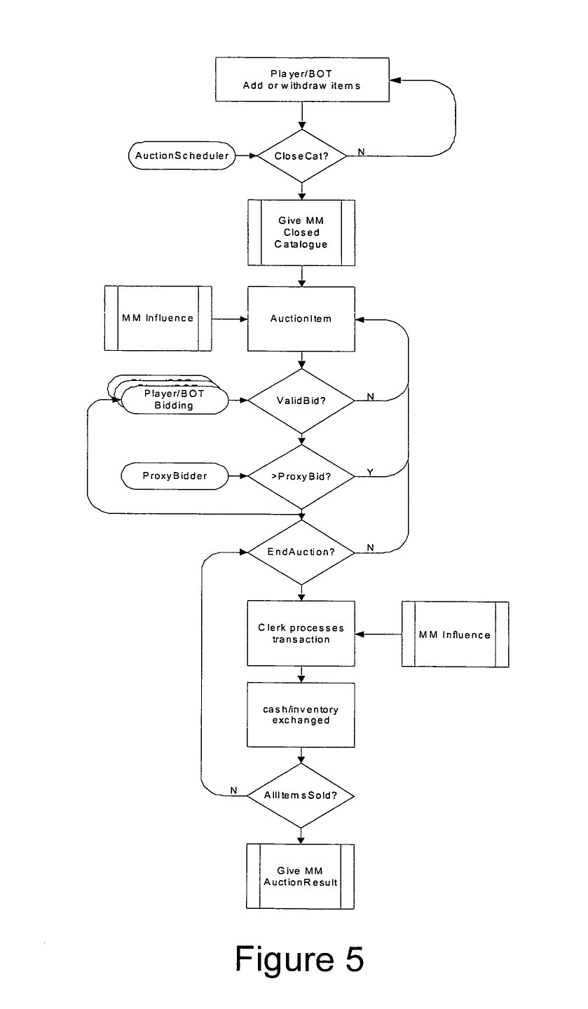

FIG. 5 shows a process flow chart of the above auction process.

Products in the game have the following qualities:
Category (e.g. ‘hi-fi amplifier’, ‘high heels’,).
Brand name.
Product model.
Picture.
Link to real-world product.
Real-world recommended retail price.
Average in-game retail price.
Price—current price if being sold; last bought price for inventory.
Price category—expensive/average/cheap.

Products are classified in different product categories. The categories represent specific types of product, for example amplifiers, men's sandals, high heel shoes, CD player, speakers etc. By using a product category classification system, this enables players to be creative in selecting products to complete the client contract, as any product within the category may be substituted with another product in the same category.

As described above, the Market Model 206 monitors data in the market system 202 and the client market 204. Using this data, the Market Model calculates the state of the virtual market and to make predictions for the future state of the virtual market. The Market Model 206 attempts to balance the gameplay and attempts to stabilise the virtual economy by controlling one or both of supply and demand of the products in the virtual environment. Furthermore, the Market Model 206 is capable of implementing a number of anti-collusion mechanisms to prevent players artificially increasing or decreasing the virtual price of products by colluding with one another.

The demand for products within the virtual environment is determined by the selection of products forming part of the sets of tasks in the client contracts. When the Market Model 206 determines that the supply of certain products should be increased, a command is issued to the client market 204 to issue contracts containing the specified product. As such, more players will demand the specified product because more contracts require the specified product to complete the client contract.

The Market Model 206 can issue commands to increase demands for specific products or commands to increase demand for specific categories of products. For example:
Issue client contracts with sets of tasks totalling n category A products.
Issue client contracts with sets of tasks totalling n category B products.
Issue client contracts with sets of tasks totalling n category C products.

The Market Model 206 increases the supply of products into the virtual environment by increasing the number of products in a particular category in the virtual auction environment in the market system 202. In practice, the Market Model 206 issues a command to a virtual merchant character provided by the virtual character engine 208 to sell particular products, or products within a product category, to satisfy the contracts issued to the players within the virtual environment.

The commands may take the form of:
Release n category A products.
Release n category B products.
Release n category C products.

A request from the Market Model 206 for n category A products is translated into actual products entering the virtual environment by either randomly selecting products from a product database that fit the correct category or giving preference to products that are currently being promoted in the virtual environment. Once selected, the products are released into the virtual environment via a virtual auction house in the market system 202.

The Market Model 206 may also implement a number of anti-collusion mechanisms. One such mechanism is setting a maximum sale price of any product within the virtual auction environment. As such the Market Model 206 prevents players from setting a high sale price, which could be used to transfer large amounts of virtual credit from one player to another. The Market Model 206 determines a maximum selling price for each product dependent on a percentage above the average in-game price, for example 50% and above the average in-game price. Players are unable to buy items above this maximum price. The Market Model 206 issues commands to the virtual auctioneer in the market system 202 should the maximum price be reached. In such a situation, the product will be sold to the first person offering the maximum price.

Furthermore, by virtue of using virtual auctions within the virtual environment, players are prevented from selling items for little or no value in order to assist other players in completing their tasks. A player attempting to do so has no control over the auction and other players are free to bid on the products within the auction environment.

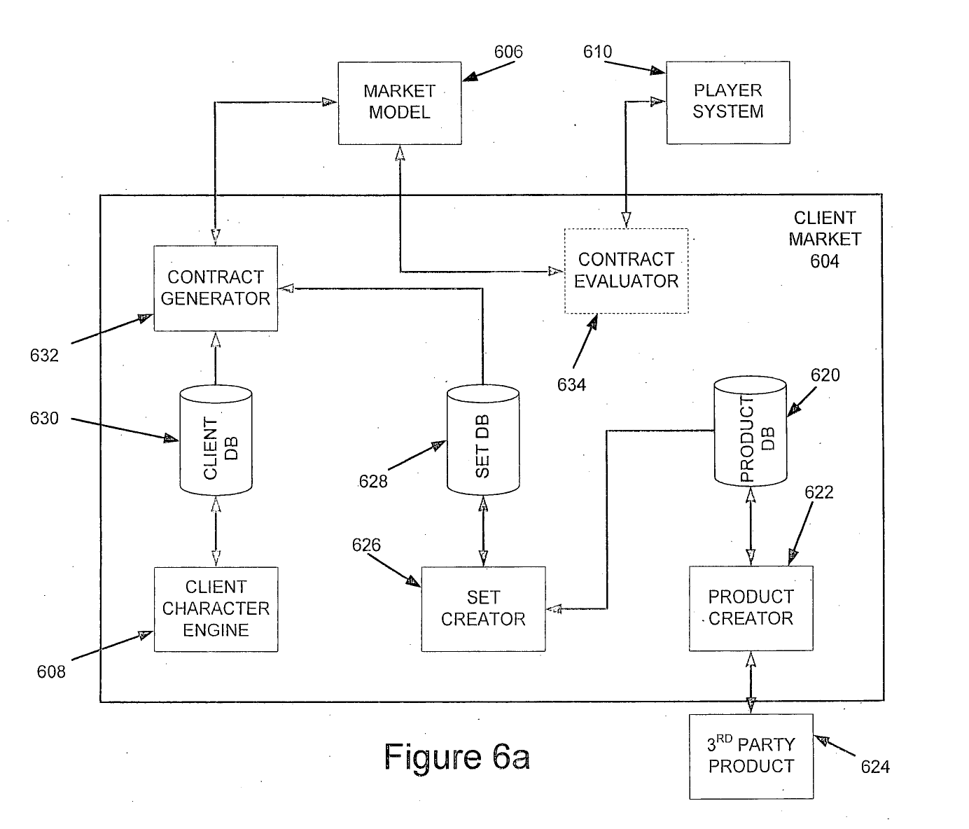

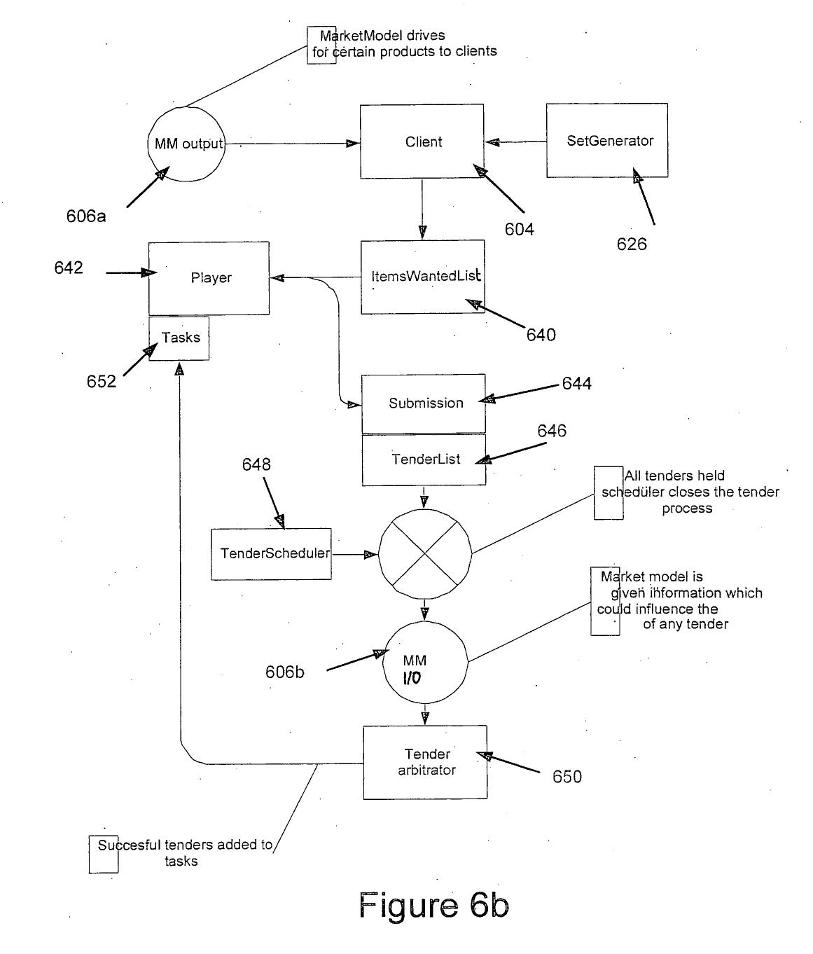

FIG. 6a shows a more detailed systems view of the client market 604. Data relating to the products are contained in a product database 620. Virtual representations of the products enter the product database 620 via the product creator 622, which receives data from third parties 624. The product data contained in the product database 620 is used by a set creator 626 to create sets of tasks comprising the products. Once created, the sets of tasks are stored in a set database 628. The sets of tasks contained in the set database 628 are fed into a contract generator 632.

Data from a client database 630 feeds into the contract generator 632. A client character engine 608, which is a virtual character engine, generates at least one client having a client persona. The client persona will influence the selection of products presented in a contract.

The Market Model 606 monitors the contracts being generated in the contract generator 632 and may also influence the contracts being generated in the contract generator 632. As discussed above the Market Model 606 may influence the products forming part of the contracts in order to increase or decrease the demand for products within the virtual environment. The client market 604 also evaluates the contracts using the contract evaluation module 634. The contract evaluation module communicates with the player 610 and Market Model 606 to determine whether the contract has been completed and to evaluate the performance of the player based on the contract.

Client contracts have the following qualities:
Client (the virtual client character that is offering the contract).
Set of tasks defining the selection of products required by the client.
The time limit in which the player has to fulfil the contract.
iPoints offered.
Maximum set price (the highest price that the client will pay for the selection of products within the set of tasks).
Penalty for failure to complete the contract (for example loss of iPoints, iDosh, skill etc.).

The contracts may be one of a low-level contract, an advanced contract or a player initiated contract. A low-level contract comprises up to three products and the contract is merely issued to the players. Advanced contracts comprise up to five or more products (depending on the game being played) and are auctioned in the virtual auction environment of the client market 604. Advanced contracts also contain penalties for failure to complete the contract. Furthermore advanced contracts may be ambiguous, that is requirements from a client to “get a home cinema system” or “get fashionable clothes”. Finally, player initiated contracts are contracts that are offered to clients by the players in order to provide the client with products that they may like.

Each of the client's contracts has a time limit in which they wish their order to be completed. If the time limit runs out before successful completion of the contract by the player there may be penalties associated with not completing the contract. Time limits will typically be in the order of one to three days but may be more or less, depending on the products required by the contract.

The clients will appear, to the players, to evaluate the contract once the contract has been completed. In practice, the contract is evaluated by the contract evaluation module 634. The contract will be evaluated based on the category, brand, model and average in-game retail price of the products to determine whether the contract has been completed within the contract price.

As discussed above, the virtual client characters have their own individual preferences dictated by their persona. In practice, each of the clients is represented by a caricature. Each client has a unique name, brand preferences and favourite colour. The brand and colour preference may either be stated explicitly or will need to be determined by the player during gameplay. Examples of the virtual client characters and their favourite brands are as follows:
Society girl—Madrid Ramadas (Apple, Marc Jacobs, Ferregamo, Coach, Casual Canine)
Rock Star—Iggy Moon (Doc Martens, Rocstar Games, Buddhist Punk)
Airline Pilot—Steve Gordon (Ralph Lauren, Breitling, Toshiba)
Rap Artist—Dicey D. (Cristal, Gucci, Rolex, Tommy Hilfiger, Sony)
Computer geek—Barry Bates (Microsoft, Dell)
Desperate Housewife—Sally Stevens (Gap, Smeg, OshKosh, Bodum)
Italian Playboy—Gianni Ginanellini (Armani, Versace, Bulgari, La Marzocco)
Theatre Actor—Imelda Saunderson (Chanel, Prada)
Movie Star—Desmond Deed (Cole Haan)
Starlet—Marlene Montgomery (Fendi)
Opera Diva—Renata Cantanata (Versace, Valentino, Ferragamo, Nuova Simonelli)
Prima Ballerina—Marie-Élise Sauter (Dior, Yves St Laurent, Hermes)
Tycoon—J. Jordan Kelly (Hugo Boss)
Billionaire—George G. Vanderhouse (Paul Smith)
Footballer—Atilio Delgado (Nike)
Footballer's wife—Tanya Delgado (Jimmy Choo, Moschino, Le Creuset)
F1 driver—Hans Hoffmeir (Tag Heuer, Hugo Boss, Samsung, Joe Rocket)
Newlyweds—Jon and Jan Jordon (Westinghouse, Kodak)
Posh gits—Tips and Pippa Farthington-Smythe (Louis Vuitton, Aquascutum, Max Mara)
Polo Player—Manuel Antonio Martinez (Paul Smith)
Model—Whispy LaFontaine (Miu Miu, Manolo Blahnik, Vera Wang)
Actress—Landry Gleason (Calvin Klein)
Country Music singer—Tawny Torrent (Ralph Laurent)
New York Artist—Andre Rachenko (DKNY, Canon, Apple)
Harvard Rich Kid—Chip Westlake (Adidas)
Beverly Hills Prom Queen—Tiffany Goldman (Cartier, Steve Madden, Apple)
Porn Star—Honey Love (Miss Sixty, Sketchers)
Essex Girl—Saskia Cavendish (Louis Vuitton, Burberry)
Hard-core Gamer—‘Frag’ Wilson (Microsoft, EA)
Playboy Model—Tuesday November (Nine West)

Clients offer the contracts via a virtual auction within the client market 604. Client auctions are sealed bid auctions where each player puts in a bid. Players are therefore unaware of other players' bids. The aim is to award the contract to the player with the lowest bid. However, the contract may be awarded to other players dependent on other parameters as discussed below.

FIG. 6b shows a functional map of the operation of the client market 604. The client 604 issues a contract containing the desired set of products 640 dependent on an input from the set generator 626 and the Market Model 606a. A player 642 then submits a bid 644 which is collated in a tender list 646. A tender scheduler 648 schedules the various contracts and related player bids for the virtual auction.

The Market Model 606b receives tenders from the tender scheduler 648 and provides an output to a tender arbitrator 650. The tender arbitrator 650 determines whether a bid is accepted and issues the contract 652 to the winning player 642. The tender arbitrator 650 determines whether to award a contract to a player dependent on at least the lowest price offered by the player and characteristics or skills of the bidding player. The Market Model 606b is therefore capable of influencing the awarding of the contracts to players in order to influence and balance the virtual market through the tender arbitrator 650.

The virtual character engine 208 is configured to provide at least one virtual non-avatar character in the virtual environment such that players may interact with the virtual non-avatar character. As well as the virtual client as described above, the virtual character engine 208 may provide other virtual characters.

One such other virtual character is a virtual player. Virtual players are capable of buying and selling products in the virtual environment and interacting with other players to play the game. The virtual players play the game according to a set of rules. These rules may be predefined or may be adaptive. Virtual player characters have a product inventory in which they may keep products and may bid on client contracts in order to acquire a contract for a set of products. The virtual player characters may also buy and sell products within the virtual auction environment of the market system 202 in order to satisfy the acquired client contract. The virtual player characters play the game in such a way that they are substantially indistinguishable from other players operated by humans.

Alternatively, instead of a virtual character engine separate from the market system providing the virtual players, a virtual character engine residing in the market system may provide the virtual players.

Another virtual character provided by the virtual character engine 208 is a virtual merchant. The virtual merchant is a non-player character that controls the release of one or more of the products into the virtual environment by selling one or more products into the virtual environment under the control of the Market Model 206. Virtual merchants only sell products; they do not buy products or compete with players (virtual and real) for client contracts.

A request for n category X products from the Market Model 206 instructs the virtual merchant to advertise such products within a virtual auction. The products may be specific products or may be randomly chosen from the product database in accordance with the correct product category. The virtual merchant places the products in any number of virtual auctions and keeps auctioning the products until the resource has sold out.

Alternatively, instead of a virtual character engine separate from the market system providing the virtual merchants, a virtual character engine residing in the market system may provide the virtual merchants.

The player system 210 acts as an interface between the player GUI 212 and the rest of the system within the game environment 200. Each player character has the following properties:
Wallet holding the player's iDosh.
PointBank holding the player's iPoints.
Inventory—a list of products currently owned by the player. Products in auction are also represented but are not available or other use. Products tied to a given client contract are not available for other use.
Contracts—holds the contracts that are currently in progress.
GameState—holds data relating to the game in progress, e.g. player position, time remaining.
Skills.

Through the player system 210 the player is capable of interacting with other players in the market system 202 and acquiring contracts from the clients in the client market 204.

Players are allocated and may obtain skills whilst playing the game. Skills may be acquired by successful completion of the contracts or purchased using players iPoints. Skills are lost through time (they decay over time, which requires players to keep playing the game), unsuccessful contracts (failure to complete the contract in the specified time), and cashing in for iDosh. The different types of skills are broken down into three main sections: buying, selling and client. A player may acquire new skills or improve on the skills he already has through successful completion of the client contracts. However, the player may also lose the skills through failure to complete the contracts.

The buying skills are as follows:
Canny bidder: This skill affects the number of products a player may watch or bid on in a virtual auction, display on the screen, or place ProxyBids.
Warehousing: Having this skill increases the number of product entries a player may have in his inventory.
Back hander: Enables more iPoints or iDosh to be obtained for completing a client's contract.
Market Analyst: Enables a player to obtain market history on product prices so that player may track trends.
Insider Information: Enables a player to preview an auction house catalogue before it is public.
Bargain Hunter: provides a player with extra information on the auction highlighting products that are still below market average price.
Marketing Whizz: Enables lower fees.

The selling skills are as follows:
Marketing Whizz: Players pay lower listing fees.
Super Seller: Entitles the player to pay lower sales commission
Early Bird: Entitles a player to an earlier time stamp for products submitted to a virtual auction catalogue.

The client skills are as follows:
Wheeler Dealer: Clients are more lenient when players complete sets with non-optimal products.
Client Juggler: Enables a player to increase the number of client contracts that the player can handle at any one time.
Client Intuition: Provides additional information/clues to client's preference and ambiguous contracts.
Trusted Trader: Enables the player to win client bids if a number of bids are tied or even if the player's bid is not the lowest.
Backhander: Provides the player with more iPoints or iDosh for completing a client's contract.

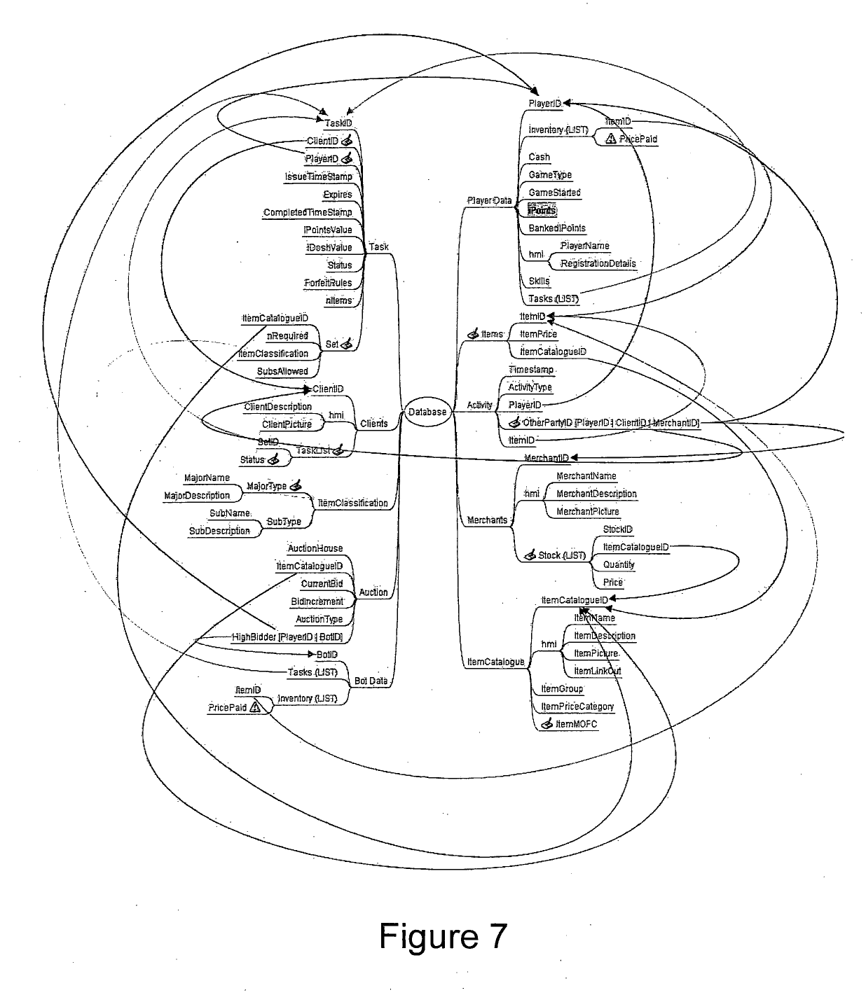

FIG. 7 shows a database structure of the game. The database is relational and uses field indexing. The connecting lines describe directly mapped relationships between fields of separate database tables.

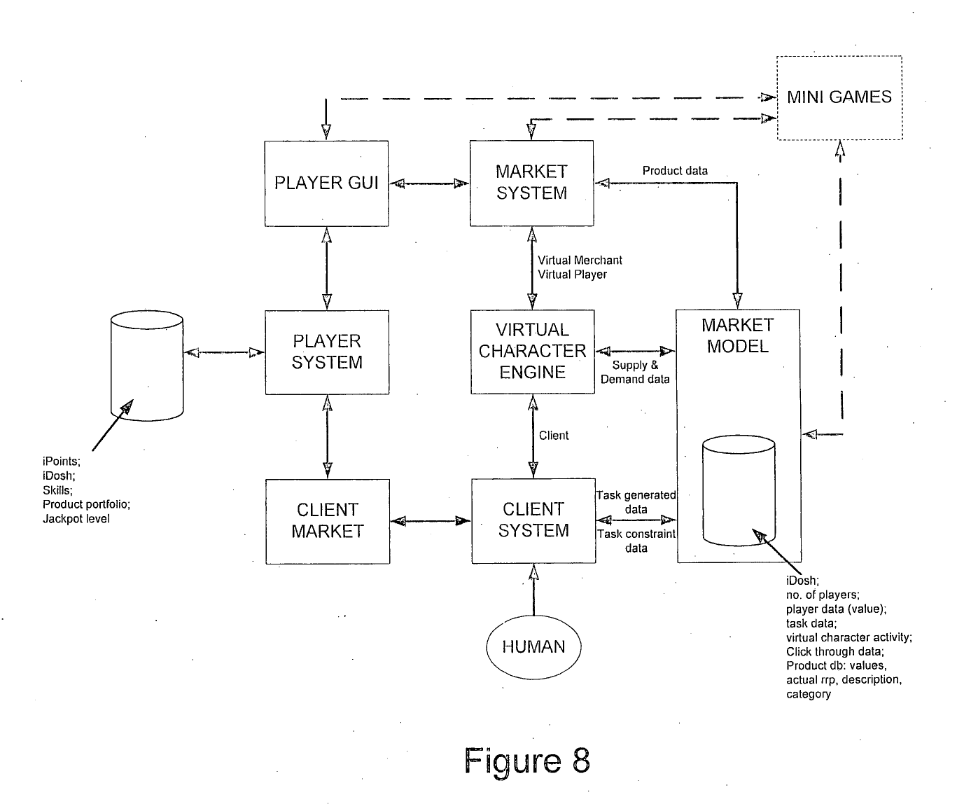

FIG. 8 shows a more detailed system overview of the game environment.

The player Graphic User Interface (GUI) 212 enables the player to interact in the game environment to play the game. In a preferred embodiment, the player GUI 212 comprises a set of web pages to retrieve and display data. As well as enabling the players to play the game, the GUI enables a player to view representations of real-world products from the one or more real-world companies and also to redeem iPoints against real-world products from the real-world companies represented in the virtual environment.

A second bottle-neck with data flow is between the player GUI 212 and the player system 210. A number of techniques are used to optimise the data flow between the components, including tokenising, update deltas and caching where possible. Use is also made of closely tied processes using IPC, RPC and SysV shared memory to reduce the time required to process a given request on a server running the processes.

Furthermore to ensure that the player GUI does not waste server resources with excessive polling, a piggy-backing technique is used to bundle multiple requests and responses. As such, the data flow is reduced.

Each web page may consist of one or more of static content elements, active content elements and timed update content elements.

Static content elements are capable of displaying static content, which remains fixed during a display time of the web page. The active content element is capable of displaying active content, which is changeable during a display time of the web page. The active content is changeable in response to interaction local to and remote from the GUI. The timed update content element is capable of displaying timed updated content, which is changeable during a display time of the web page. The timed update content is changeable in response to an expiration of a period of time.

The static content, active content and timed update content comprise at least one of text, images and sounds.

The relationship between the different types of content is flexible, for instance clicking on a static item could trigger a data update elsewhere on the GUI, or clicking an item that was generated by a timed updated could generate a separate active event. In a preferred embodiment the above three types of content will co-exist on any web page at any given time.

The player GUI 212 may also provide a feedback form for the player to provide feedback on the game.

The player is able to view and to purchase real-world products represented within the virtual environment via the player GUI. The player is presented with screens containing graphics and data associated with the product. The player may then purchase the product via the game. Alternatively, the player is directed to a third party's website, from which the product may be purchased. The player may purchase the product using money, redeemed using iPoints, or a combination of both.

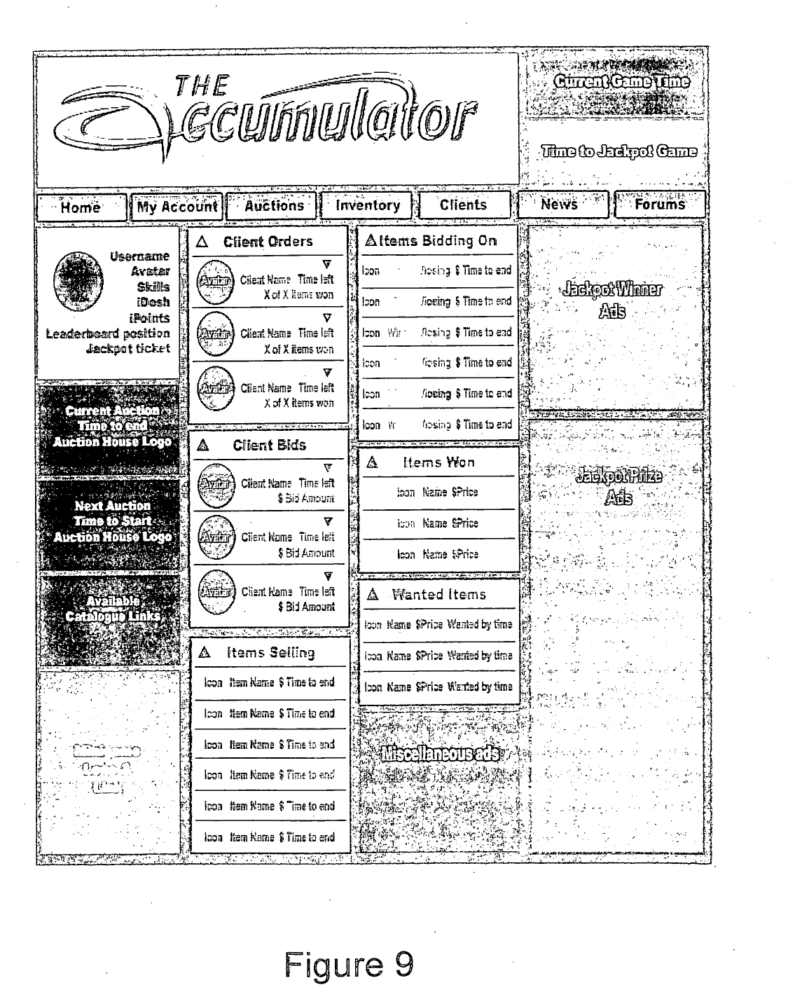

FIG. 9 shows an example player GUI presented to a player once logged into the game. The home page presents a plurality of data to the player. The screen may display, for example, a head-up display (HUD), data relating to the clients, a player product inventory, a virtual auction, data relating to the present game and news.

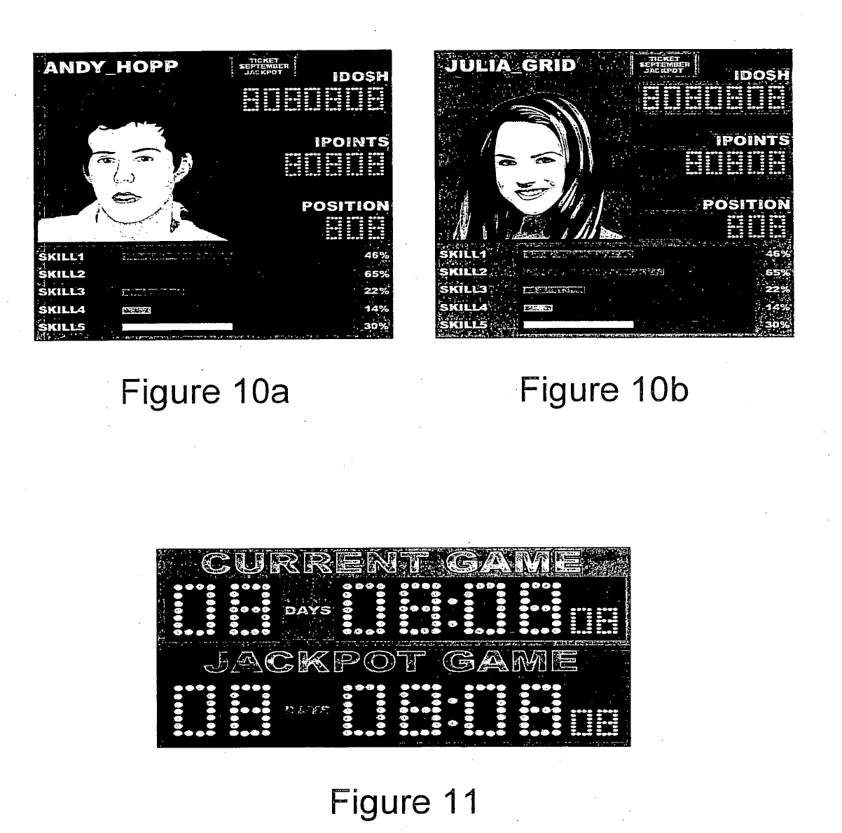

FIGS. 10a and 10b show example player HUDs, which display a plurality of data relating to each player. In the examples shown, the HUD displays a player name, a player avatar, the player's iDosh, the player's iPoints and the player's position within the game. The HUD further shows the player's individual skills in an associated graphic.

FIG. 11 shows a time display, displaying the remaining time to the end of the current game and any other additional games being played in the system. The time display is displayed on all pages so that the player may be aware of the remaining time at all times during the gameplay.

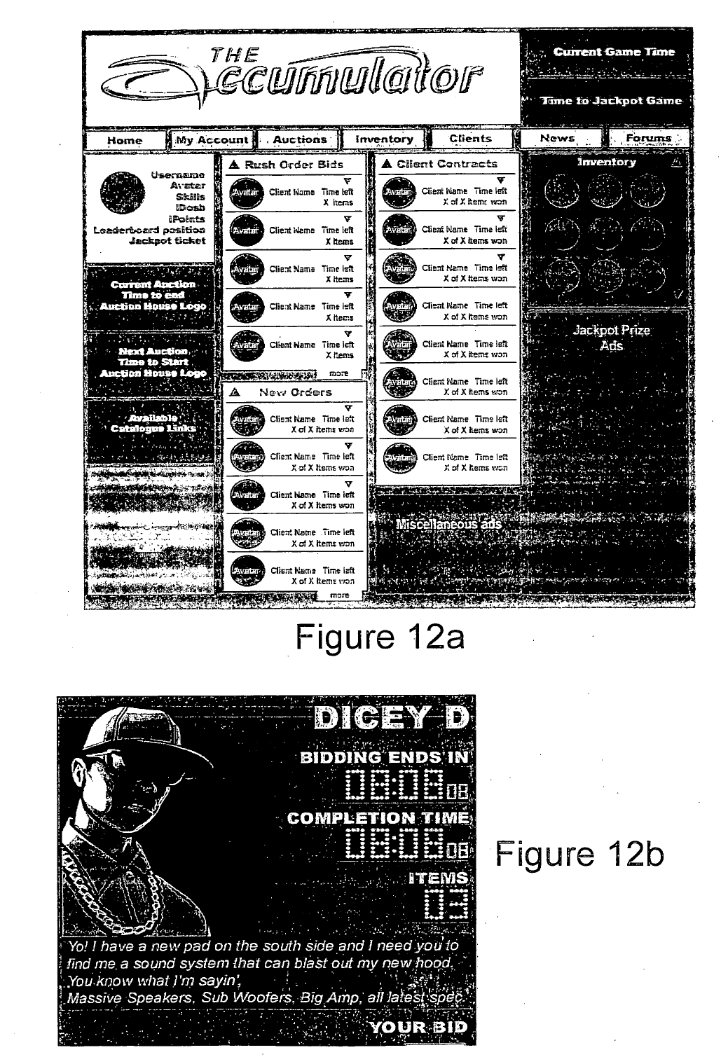

FIG. 12a shows the home page display client related data. FIG. 12b shows an example graphic that is displayed to a player once in the client market. The client publishes the contract and the player may place a bid in the appropriate box in order to attempt to acquire the contract. The graphic displays all information relevant to enable the player to place reasonable bid.

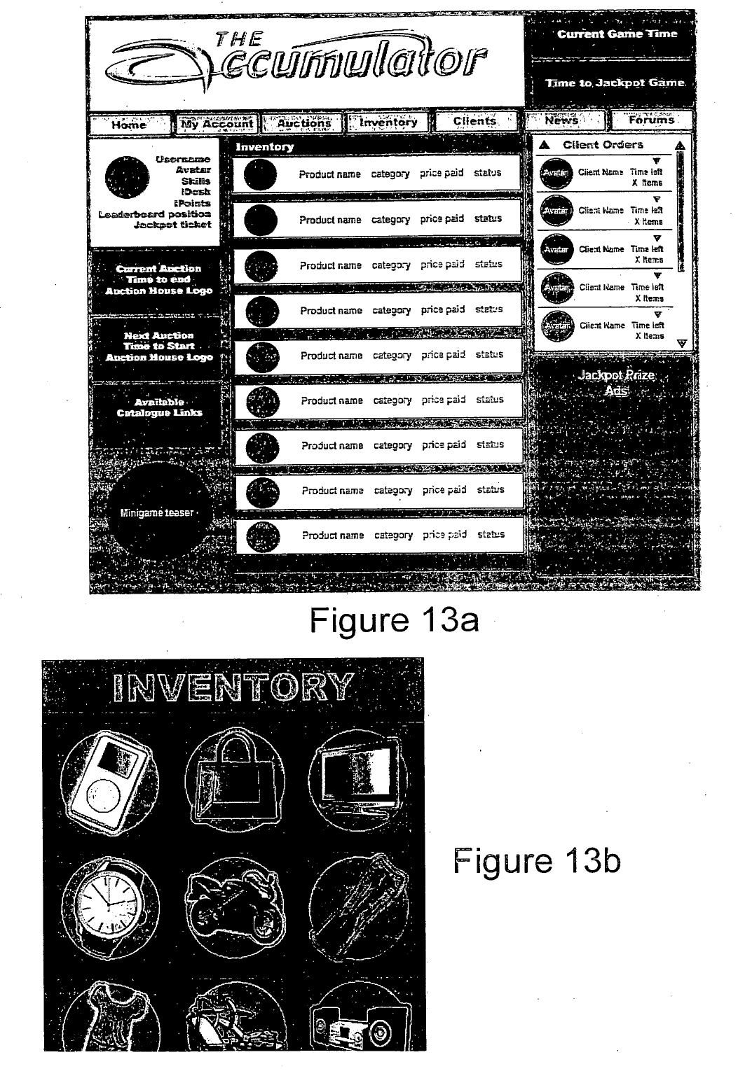

FIG. 13a shows the home page displaying inventory data. FIG. 13b shows an example graphic used to display the player's product inventory.

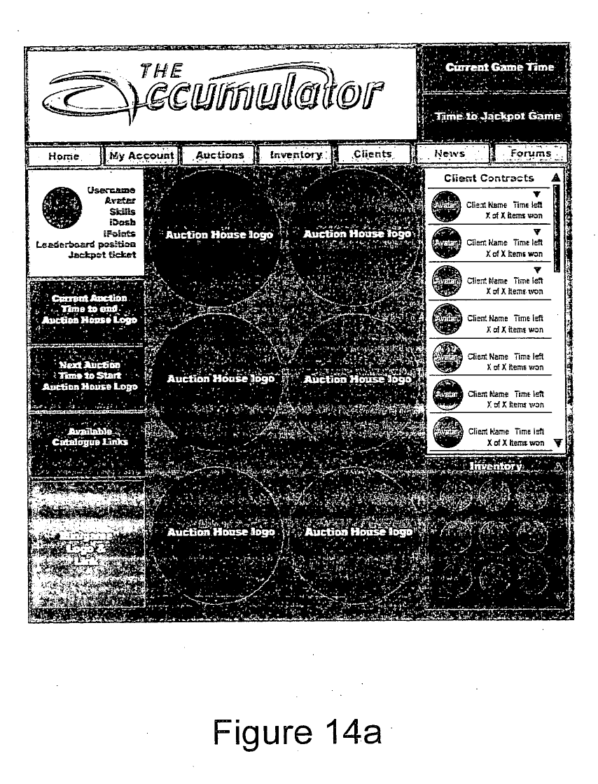

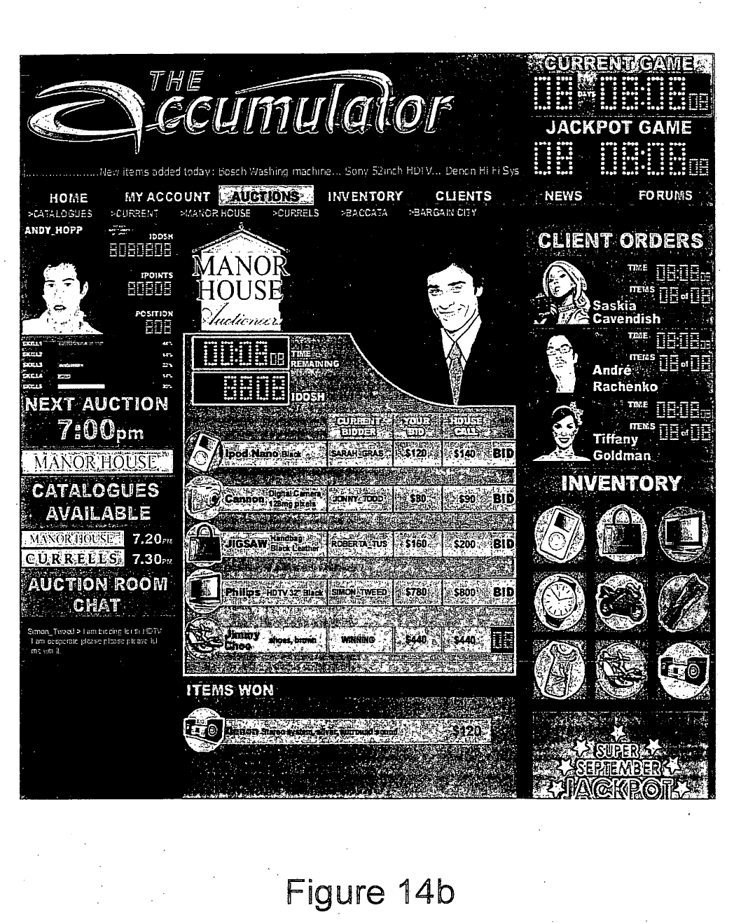

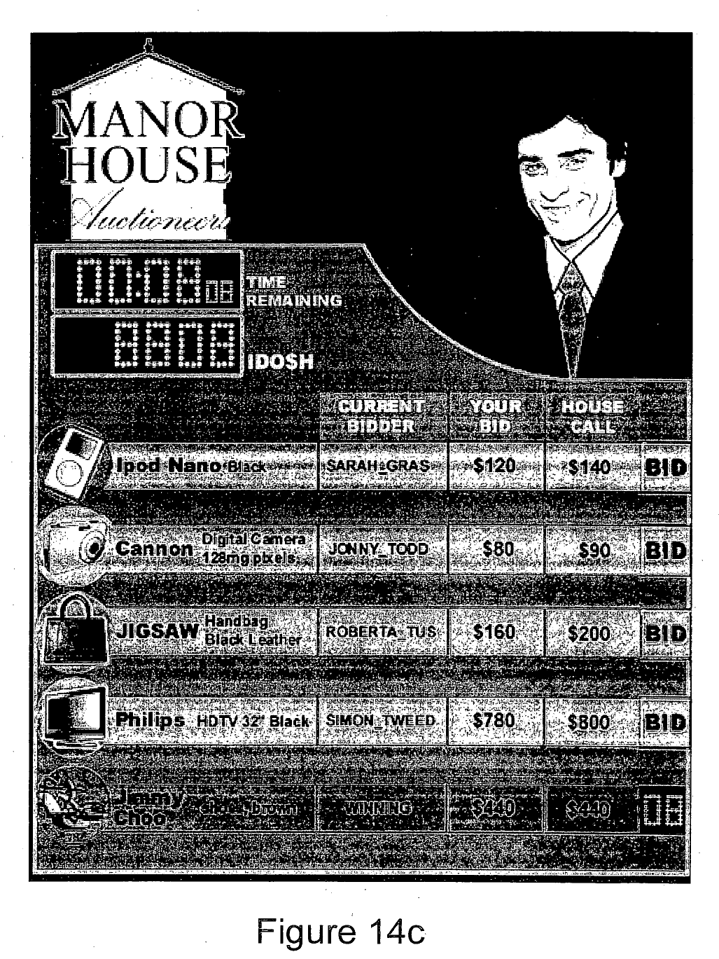

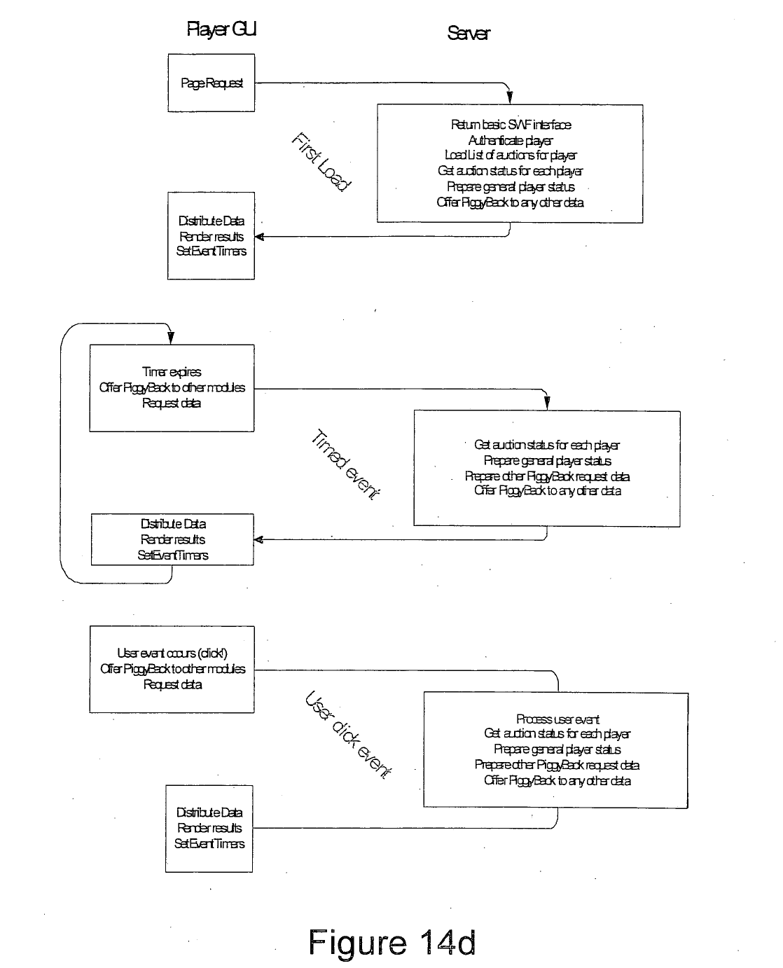

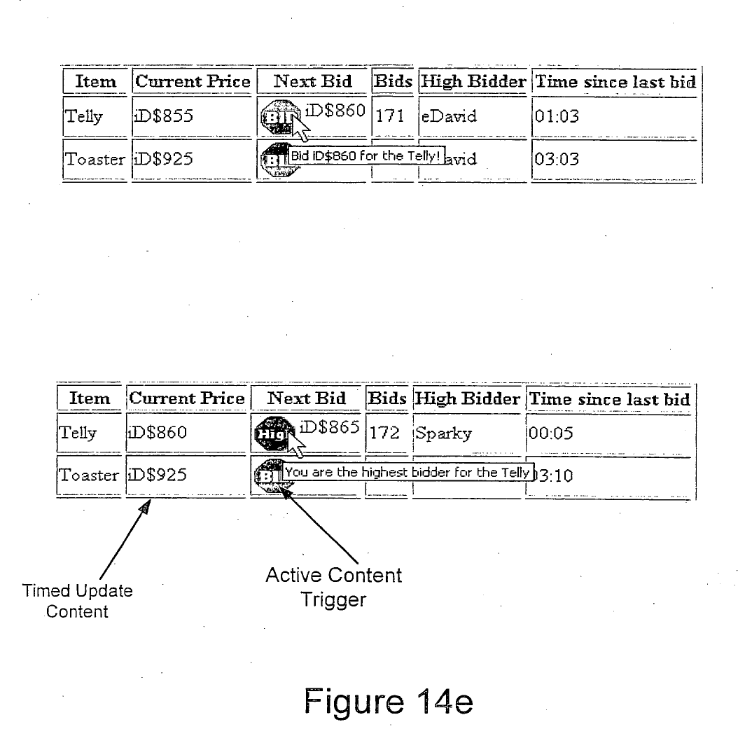

FIG. 14a shows the home page displaying auction catalogue data. FIG. 14b shows a more detailed graphic of the auction environment. FIG. 14c shows the centre panel of the auction page in greater detail. Sufficient data relevant to the auction is displayed to enable the player to take part in the virtual auction. As can be seen in this example, the product description is displayed together with the name of the current bidder, the value of the bid and various timers.

FIG. 14d shows three example situations during the lifetime of the auction page. The first shows when the data is first loaded; the second is a timed event; and the third is a user click event.

FIG. 14e shows a portion of the GUI graphic that enables the player to take part in the auction. In the example shown, clicking the “BID” icon would initiate an active event that would register a bid with the virtual auctioneer. Assuming the bid was successful, the image would be changed to another graphic to indicate that the player is the high bidder.

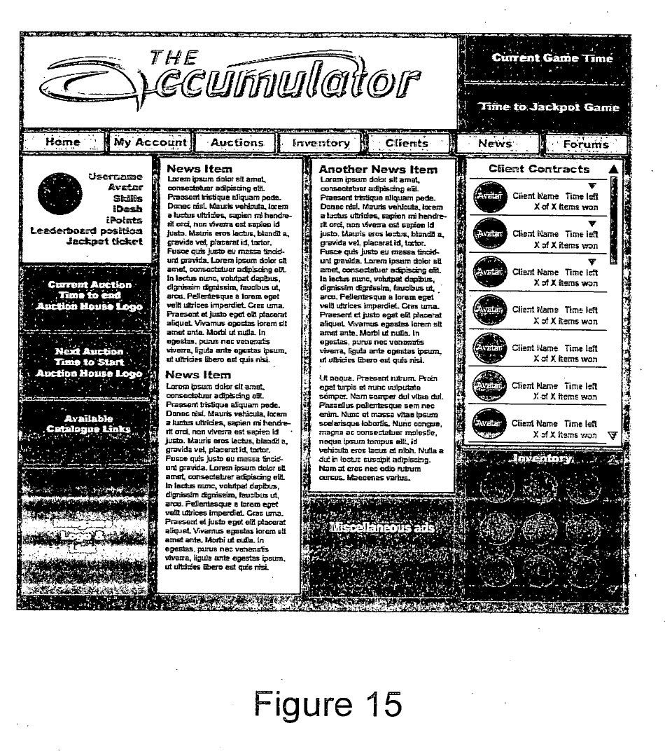

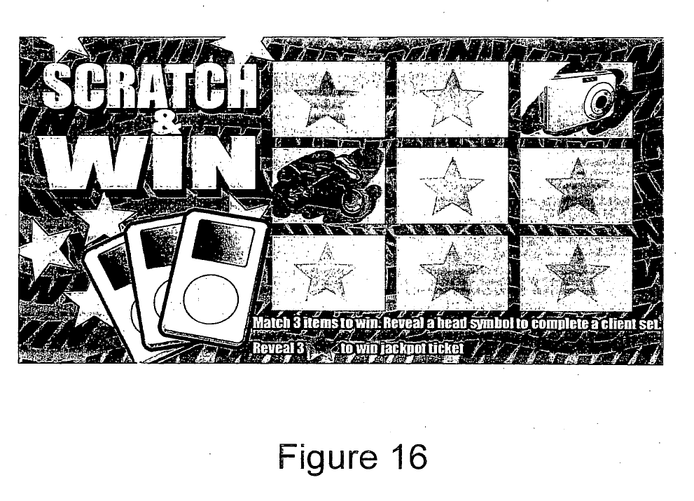

FIG. 15 shows the home page displaying news content, such as general news items relating to the game and its maintenance.

As well as participating in the above trading electronic game, the players may also participate in a number of additional games within the virtual environment. One such example of an additional game is a jackpot game, in which the prizes for winning the game are higher than that in the main game. For example, cash prizes may range from between US$50,000 to US$250,000, depending on the expected number of players signing up to the game. The jackpot game takes place less frequently than the main game, for example monthly, and lasts for a predetermined amount of time, for example one week. Players enter the jackpot game by using iDosh or iPoints to buy entry. The winner of the game is the player who collects the most iPoints by the end of the game. Similar to the main game, the jackpot game requires the player to complete client contracts.

The client contracts of the jackpot game are typically more difficult than that in the main game and may require a larger number of products to be acquired in the virtual environment.

Additional games to the system include minigames, which provide an amusing diversion for players, perhaps whilst they are online and waiting for a virtual auction to start. In keeping with the main game, the subject matter of the minigames is based on products, prices and prizes.

The minigames may be used to boost one's player skillers and to earn extra iDosh or iPoints or even prizes. The frequency of minigames made available to the player at any one time is determined by the Market Model. Example minigames include: Product Bingo; Client Bingo; the Estimator; Pass the Product and timed buying tasks.

In Product Bingo, the player receives a ‘bingo card’ showing a random selection of icons relating to a selection of category of products in their inventory at that time. A virtual dispenser dispenses icons at random that display products of various categories. The player must match the randomly generated product icons with the product icons in the player's inventory in order to complete the bingo card. The game finishes when the random icons run out or the player complete a line of products on his bingo card.

In Client Bingo the mechanism is substantially similar to that of the Product Bingo. However, the bingo cards features graphics of clients instead of product categories. Clients appearing on the player's bingo card are limited to a selection of those the player has dealt with in the past. The longer the player has been playing the game, the more clients they will have dealt with, hence the better the chances they will have of completing a line or a card.

The Estimator is a classic auctioning game. A product in an upcoming auction is selected at random. Players guess what the highest price paid for that product will be. The first, highest, unique guess will win. This minigame is advertised within the virtual auction area.

The Pass the Product minigame is a virtual equivalent of a “pass the parcel” game. A selected product is passed around participating players for a randomly generated time. Once a player receives the product they must pass it to another player within a predefined time, for example a few seconds. The player holding the product at the end of the time is the winner.

The timed buying tasks game challenges players to find and buy a preset number of products in a short time frame (for example five minutes). The products required in the short time frame may have some arbitrary characteristics in common, for example beginning with the letter Q or costing 100 iDosh credits.

Additional games include scratch card games and one-armed bandits.

In the scratch card game, the principle is similar to that of a real-world scratch card where icons representing prizes are obscured by patches which, when scratched off, reveal the icons. A player wins when a line of matching icons is revealed. FIG. 14 shows an example screenshot for a scratch card game.

The one-armed bandit is similar to that of a real-world slot machine. The player uses iPoints to play the game and a graphic displays a number of rotating wheels showing different icons. The player wins additional iPoints or iDosh when the icons match.

In an alternative embodiment, products are brought and sold within the virtual auction environment in the market system via a sealed bid auction. In sealed bid auctions, the player offering the highest bid is awarded the product. Other players' bids are not visible to the player placing the bid.

In a further alternative embodiment, iDosh may have an associated monetary value. As such, players may purchase more iDosh within the game to enable them to purchase more expensive products.

All right including copyright in the material obtained in the figures and, in particular the screenshots, are vested in and the property of the assignee of the present invention. The assignee retains and reserves all rights in the figures and, in particular the screenshots, and grants permission to reproduce the material only in connection with reproduction of the granted patent and for no other purpose.

No doubt many other effective alternatives will occur to the skilled person and it will be understood that the invention is not limited to the described embodiments and encompasses modifications apparent to those skilled in the art lying within the spirit and scope of the claims appended hereto.

1. An electronic game in which multiple players interact in a virtual environment to buy and sell products to acquire points, said electronic game comprising:
a game engine configured to publish contracts in said virtual environment and configured to enable a said player to acquire a said contract, said contract defining at least a set of tasks for a said player to complete, a said set of tasks defining a selection of products to acquire in said virtual environment, said products being virtual representations of real-world products from one or more real-world companies;
wherein said players are allocated said points in response to successful completion of said tasks; and
wherein said points are redeemable against real-world products from said one or more companies represented in said virtual environment of said game.

2. An electronic game according to claim 1, further comprising an auction engine to provide a virtual auction environment to enable said players to buy and sell said products.

3. An electronic game according to claim 1, further comprising an auction engine to provide a virtual auction environment in which said contracts are published, and wherein said auction engine enables a said player to take part in a reverse auction to acquire a contract defining a said set of tasks.

4. An electronic game according to claim 3, wherein said auction engine is further provided with a tender arbitrator, said tender arbitrator determining whether to accept a bid placed by said player for said set of tasks based on at least the lowest bid placed by said player and an attribute of said player.

5. An electronic game according to claim 4, wherein said attribute of said player includes player skill.

6. An electronic game according to claim 1, further comprising a market model, said market model monitoring product data in said virtual environment, said product data comprising at least product demand data, product supply data and product price data, said market model regulating one or both of supply and demand of said products in said virtual environment based on said product data.

7. An electronic game according to claim 6, wherein said market model regulates said supply of said products by instructing a virtual non-player character to sell one or more of said products in said virtual environment.

8. An electronic game according to claim 6, wherein said market model regulates said demand of said products by defining said selection of said products in said set of tasks responsive to said product data.

9. An electronic game according to claim 6, said game further comprising a data store to store said product data and wherein said market model is coupled to a data pre-processor to cache said product data from said data store.

10. An electronic game according to claim 1, wherein said game is configured to set a maximum price at which said product may be sold within said virtual environment.

11. An electronic game according to claim 1, further comprising at least one virtual character engine, said virtual character engine being configured to provide at least one virtual non-avatar character in said virtual environment such that said players may interact with said virtual non-avatar character.

12. An electronic game according to claim 11, wherein said virtual character is a client, said client being an in-game character that publishes said contracts in said virtual environment, said client rewarding said players with virtual credit for successful completion of said contracts.

13. An electronic game according to claim 12, wherein a said client has a persona, and wherein said selection of products in said sets of tasks published in said contracts by said client is dependent on said client persona.

14. An electronic game according to claim 11, wherein said virtual character is a virtual player, said virtual player being capable of buying and selling said products in said virtual environment according to a set of rules.

15. An electronic game according to claim 11, wherein said virtual character is a virtual merchant, said virtual merchant being a non-player character that controls the release of one or more of said products into said virtual environment.

16. An electronic game according to claim 15, further comprising a market model, said market model monitoring product data in said virtual environment, said market model regulating one or both of supply and demand of said products in said virtual environment based on said product data and wherein said virtual merchant controls the release of one or more of said products by selling said one or more products into said virtual environment under control of said market model.

17. An electronic game according to claim 1, further comprising a market model, said market model monitoring product data in said virtual environment, said market model regulating one or both of supply and demand of said products in said virtual environment based on said product data and further comprising a contracts engine, said contracts engine generating said contracts for said game engine in response to data from said market model.

18. An electronic game according to claim 17, wherein said contracts engine defines a number and category of said products forming said set of tasks.

19. An electronic game according to claim 17, wherein said contracts engine defines at least one of:
a time said player has to fulfil said contract;
a number of points awarded for completion of said contract; and
a number of points deducted from said player for failure of said contract.

20. An electronic game according to claim 1, wherein said completion of a task requires a said player to navigate through one or more screens of game-related information for performing a said task, and wherein a said screen includes electronic advertising material for at least one of said real-world products to which said tasks pertain.

21. An electronic game, in which multiple players interact in a virtual environment to buy and sell products to acquire points, said electronic game comprising:
a contract in said virtual environment, said contract being acquirable by a player, said contract defining at least a set of tasks for said player to complete, said set of tasks defining a selection of acquisitions including a product in said virtual environment, said product being virtual representations of a non-virtual product from one or more real-world companies; and
a value related to said contract, wherein said players are allocated said value in response to successful completion of said contract tasks, and wherein said value is redeemable against real-world products from said one or more companies represented in said virtual environment of said electronic game.

22. An electronic game according to claim 21, further comprising an auction engine to provide a virtual auction environment to enable said players to buy and sell said products.

23. An electronic game according to claim 21, further comprising an auction engine to provide a virtual auction environment in which said contracts are published, and wherein said auction engine enables a said player to take part in a reverse auction to acquire a contract defining a said set of tasks.

24. A player graphic user interface (GUI) for use with an electronic game in which players interact in a virtual environment to buy and sell products to acquire points, said graphic user interface comprising a set of web pages, said web pages being configured to enable a player of said game to:
view published contracts in said virtual environment;
acquire said contract;
complete a said set of tasks; and
view representations of real-world products from one or more real-world companies; and
wherein a said contract defines at least a set of tasks for a said player to complete, said set of tasks defining a selection of said products to acquire in said virtual environment, said products being virtual representations of said real-world products; and
wherein said web pages are further configured to enable a player of said game to redeem points allocated to a said player in response to successful completion of said tasks against real-world products from said one or more real-world companies represented in said virtual environment of said game.

25. A player GUI according to claim 24, wherein said web pages comprise:
one or more static content elements capable of displaying static content;
one or more active content elements capable of displaying active content; and
one or more timed update content elements capable of displaying timed update content.

26. A player GUI according to claim 25, wherein said static content remains fixed during a display time of said web page.

27. A player GUI according to claim 25, wherein at least one of said active content and timed updated content is changeable during a display time of said web page.

28. A player GUI according to claim 27, wherein said active content is changeable in response to interaction local to said GUI.

29. A player GUI according to claim 27, wherein said active content is changeable in response to interaction remote from said GUI.

30. A player GUI according to claim 27, wherein said timed update content is changeable in response to an expiration of a period of time.

31. A player GUI according to claim 25, wherein said static content, active content and timed update content comprises at least one of text, images and sounds.

32. A player GUI according to claim 24, wherein said completion of a task requires a said player to navigate through one or more screens of game-related information displayed by said player GUI for performing a said task, and wherein a said screen includes electronic advertising material for at least one of said real-world products to which said task pertains.

33. An electronic game server system in which multiple players interact in a virtual environment to buy and sell products to acquire points, said electronic game server system comprising:
a market system module configured to provide a virtual environment in which said players buy and sell said products; and
a contracts engine configured to publish contracts in said virtual environment, said contracts defining at least a set of tasks for said players to complete, said tasks defining a selection of products to acquire in said virtual environment, said products being virtual representations of real-world products from one or more real-world companies;
wherein said players are allocated said points in return for successful completion of said tasks; and
wherein said points are redeemable against real-world products from said one or more companies represented in said virtual environment of said game system.

34. An electronic game server system according to claim 33, wherein said market system module is configured to provide a virtual auction environment to enable said players to buy and sell said products.

35. An electronic game server system according to claim 33, wherein said market system module is configured to provide a virtual auction environment in which said contracts are published, and wherein said market system module enables a said player to take part in a reverse auction to acquire a contract defining a said set of tasks.

36. An electronic game server system according to claim 33, further comprising a market model module configured to monitor product data in said virtual environment, said product data comprising at least product demand data, product supply data and product price data, and configured to regulate one or both of supply and demand of said products in said virtual environment based on said product data.

37. An electronic game server system according to claim 36, further comprising a data store to store said product data and wherein said market model module further comprises a data pre-processor to cache said product data from said data store.

38. An electronic game server system according to claim 36, wherein said market model module regulates said demand of said products by regulating said selection of said products in said set of tasks.

39. An electronic game server system according to claim 36, wherein said market model module regulates said supply of said products by selling said products in said virtual environment.

40. An electronic game server system according to claim 36, further comprising a client system module configured to receive task constraint data from said market model module, said task constraint data defining a plurality of said products to issue in said set of tasks, and wherein said client system module generates said contracts based on said task constraint data.

41. An electronic game server system according to claim 40, wherein said client system module provides a client character, said client character being a virtual non-avatar in-game character that publishes said contracts, said client character rewarding said player with virtual credit for successful completion of said contracts.

42. An electronic game server system according to claim 41, wherein said client has a persona, and wherein said selection of products in said sets of tasks published in said contracts by said client is dependent on said client person.

43. An electronic game server system according to claim 33, further comprising at least one virtual character module configured to provide at least one virtual non-avatar character in said virtual environment such that players may interact with said virtual non-avatar characters.

44. An electronic game server system according to claim 43, wherein said virtual non-avatar character is a virtual player, said virtual player being capable of buying and selling said products in said virtual environment according to a set of rules.

45. An electronic game server system according to claim 43, wherein said virtual non-avatar character is a virtual merchant, said virtual merchant being a non-player character that controls the release of one or more of said products in said virtual environment.

46. An electronic game server system according to claim 45, further comprising a market model module configured to monitor product data in said virtual environment and configured to regulate one or both of supply and demand of said products in said virtual environment based on said product data, wherein said virtual merchant controls the release of one or more of said products by selling one or more of said products in said virtual environment.

47. An electronic game server system according to claim 33, further comprises a player module providing each of said players with a graphical user interface to enable each of said players to interact in said virtual environment.

48. An electronic game server system according to claim 33, wherein said completion of a task requires a said player to navigate through one or more screens of game-related information for performing a said task, and wherein a said screen includes electronic advertising material for at least one of said real-world products to which said tasks pertain.

49. A method of allocating points to players in a virtual environment, comprising:
publishing contracts in said virtual environment to enable a said player to acquire a said contract, said contract defining at least a set of tasks for a said player to complete, a said set of tasks defining a selection of products to acquire in said virtual environment, said products being virtual representations of real-world products from one or more real-world companies;
enabling said players to interact to buy and sell said products within said virtual environment; and
allocating said points to said players in response to successful completion of said tasks;
wherein said points are redeemable against real-world products from said one or more companies represented in said virtual environment.

50. A method according to claim 49, wherein said players buy and sell said products in a virtual auction environment.

51. A method according to claim 49 wherein said contracts are published in a virtual auction environment, and wherein said players take part in a reverse auction to acquire a contract defining a said set of tasks.

52. A method according to claim 49, wherein one or both of supply and demand of said products in said virtual environment is regulated.

53. A method according to claim 49, wherein said completion of a task requires a said player to navigate through one or more screens of game-related information for performing a said task, and wherein a said screen includes electronic advertising material for at least one of said real-world products to which said tasks pertain.

54. A carrier medium carrying computer program code to, when running, implement an electronic game in which multiple players interact in a virtual environment to buy and sell products to acquire points, said electronic game comprising:
a game engine configured to publish contracts in said virtual environment and configured to enable a said player to acquire a said contract, said contract defining at least a set of tasks for a said player to complete, a said set of tasks defining a selection of products to acquire in said virtual environment, said products being virtual representations of real-world products from one or more real-world companies;
wherein said players are allocated said points in response to successful completion of said tasks; and
wherein said points are redeemable against real-world products from said one or more companies represented in said virtual environment of said game.

55. A carrier medium carrying computer program code to, when running, implement a player graphic user interface (GUI) for use with an electronic game in which players interact in a virtual environment to buy and sell products to acquire points, said graphic user interface comprising a set of web pages, said web pages being configured to enable a player of said game to:
view published contracts in said virtual environment;
acquire said contract;
complete a said set of tasks; and
view representations of real-world products from one or more real-world companies; and
wherein a said contract defines at least a set of tasks for a said player to complete, said set of tasks defining a selection of said products to acquire in said virtual environment, said products being virtual representations of said real-world products, and
wherein said web pages are further configured to enable a player of said game to redeem points allocated to a said player in response to successful completion of said tasks against real-world products from said one or more real-world companies represented in said virtual environment of said game.

56. A carrier medium carrying computer program code to, when running, implement an electronic game server system in which multiple players interact in a virtual environment to buy and sell products to acquire points, said electronic game server system comprising:
a market system module configured to provide a virtual environment in which said players buy and sell said products; and
a contracts engine configured to publish contracts in said virtual environment, said contracts defining at least a set of tasks for said players to complete, said tasks defining a selection of products to acquire in said virtual environment, said products being virtual representations of real-world products from one or more real-world companies;
wherein said players are allocated said points in return for successful completion of said tasks; and
wherein said points are redeemable against real-world products from said one or more companies represented in said virtual environment of said game system.

57. A carrier medium carrying computer program code to, when running, implement a method of allocating points to players in a virtual environment, comprising:
publishing contracts in said virtual environment to enable a said player to acquire a said contract, said contract defining at least a set of tasks for a said player to complete, a said set of tasks defining a selection of products to acquire in said virtual environment, said products being virtual representations of real-world products from one or more real-world companies;
enabling said players to interact to buy and sell said products within said virtual environment; and
allocating said points to said players in response to successful completion of said tasks;
wherein said points are redeemable against real-world products from said one or more companies represented in said virtual environment.

58. A market system for use with an electronic game in which multiple players interact in a virtual environment to buy and sell products to fulfil a contract to acquire points, said contract defining at least a set of tasks for a said player to complete, a said set of tasks defining a selection of products to acquire in said virtual environment, said products being virtual representations of real-world products from one or more real-world companies; said market system providing a virtual auction environment to enable said players to buy and sell said products.

59. A market model for use with an electronic game in which multiple players interact to buy and sell products to fulfil a contract to acquire points, said contract defining at least a set of tasks for a said player to complete, a said set of tasks defining a selection of products to acquire in said virtual environment, said products being virtual representations of real-world products from one or more real-world companies; said market model monitoring product data in said virtual environment, and said market model regulating one or both of supply or demand of said products in said virtual environment based on said product data.

60. A client system for use with an electronic game in which multiple players interact in a virtual environment to buy and sell products to fulfil a contract to acquire points, said contract defining at least a set of tasks for a said player to complete, a said set of tasks defining a selection of products to acquire in said virtual environment, said products being virtual representations of real-world products from one or more real-world companies; said client system providing a client character that publishes said contract, said client character being a virtual non-avatar in-game character, said client rewarding said player with virtual credit for successful completion of said contracts.

61. A virtual character module for use with an electronic game in which multiple players interact in a virtual environment to buy and sell products to fulfil a contract to acquire points, said contract defining at least a set of tasks for a said player to complete, a said set of tasks defining a selection of products to acquire in said virtual environment, said products being virtual representations of real-world products from one or more real-world companies; said virtual character module being configured to provide at least one virtual non-avatar character to said virtual environment.

62. A virtual character module according to claim 61, wherein said virtual non-avatar character is a virtual player, said virtual player being capable of buying and selling said products in said virtual environment according to a set of rules.

63. A virtual character module according to claim 61, wherein said virtual non-avatar character is a virtual merchant, said virtual merchant being a non-player character that controls the release of one or more of said products in said virtual environment.

64. An electronic game in which multiple players interact in a virtual environment to buy and sell products to acquire points, said electronic game comprising:
a game engine configured to publish contracts in said virtual environment and configured to enable a said player to acquire a said contract, said contract defining at least a set of tasks for a said player to complete, a said set of tasks defining a selection of products to acquire in said virtual environment, said products being virtual representations of real-world products from one or more real-world companies; wherein said completion of a task requires a said player to navigate through one or more screens of game-related information for performing a said task, and wherein a said screen includes electronic advertising material for at least one of said real-world products to which said tasks pertain.

65. An electronic game according to claim 64, wherein said points are redeemable against real-world products from said one or more companies represented in said virtual environment.

66. An electronic game according to claim 64, further comprising an auction engine to provide a virtual auction environment to enable said players to buy and sell said products.

67. An electronic game according to claim 64, further comprising an auction engine to provide a virtual auction environment in which said contracts are published, and wherein said auction engine enables a said player to take part in a reverse auction to acquire a contract defining a said set of tasks.

68. An electronic game according to claim 67, wherein said auction engine is further provided with a tender arbitrator, said tender arbitrator determining whether to accept a bid placed by said player for said set of tasks based on at least the lowest bid placed by said player and an attribute of said player.

69. An electronic game in which multiple players can interact in a virtual environment to buy and sell real-world products, said game comprising:
one or more electronic player characters able to trade with said products;
one or more virtual trader characters able to trade with said products;
a virtual electronic market wherein said player and virtual characters are able to interact to trade with said real-world products; and
a control system comprising a market model to receive data from said virtual market for said real-world products and to control said virtual market such that one or both of supply and demand of said real-world products are regulated within said virtual market.

70. An electronic game according to claim 69, further comprising a system to connect trading of said real-world products in said virtual market with real-world prices of said products; and
a system to allow exchange of credit in said virtual market for a said real-world product.

71. An electronic game according to claim 69, wherein said control system is configured to implement one or more anti-collusion measures to restrict said trading of said electronic player characters.

72. An electronic game according to claim 71, wherein said anti-collusion measures include a price control mechanism in said virtual market.

73. An electronic game according to claim 72, where said price control mechanism comprises a price limit for a said real-world product in said virtual market based on a real-world price for said real-world product.

74. An electronic game according to claim 72, wherein said price control mechanism comprises a virtual merchant character to increase supply of a product, the price of which is to be controlled.

75. An electronic game according to claim 69, wherein said supply is regulated by controlling availability of said real-world products in said virtual market.

76. An electronic game according to claim 69, further comprising one or more client characters, said client characters issuing sets of tasks to one or both of said player characters and said virtual trader characters, a said set of tasks comprising one or more tasks, a said task comprising a requirement for a player or virtual trader character to acquire a specified real-world product in said virtual environment; and wherein said control system is configured to regulate said demand by controlling said issued sets of tasks.

77. An electronic game according to claim 76, further comprising a system to reward a said player or trader character in response to completion of a said task with one ore more of points, money for use in said virtual market, and an increased skill level.

78. An electronic game according to claim 76, further comprising an auction system for a said player or trader to acquire a said set of tasks.

79. An electronic game according to claim 69, wherein said virtual market comprises one or more auctions, a said auction comprising a system for a said player or trader character to select a set of said real-world products and to monitor and bid on one or all of said selected products using a single auction display.

80. An electronic game in which multiple players can interact in a virtual environment to buy and sell real-world products, said game comprising:
one or more electronic player characters able to trade with said products;
one or more client characters, said client characters issuing sets of tasks to one or both of said player characters and said virtual trader characters, a said set of tasks comprising one or more tasks, a said task comprising a requirement for a player or virtual trader character to acquire a specified real-world product in said virtual environment;
a virtual electronic market wherein said player characters are able to interact to trade with said real-world products; and
a control system comprising a market model to receive data from said virtual market for said real-world products and to control said virtual market such that one or both of supply and demand of said real-world products are regulated within said virtual market,
wherein said control system is configured to regulate said demand by controlling said issued sets of tasks.

81. An electronic game according to claim 80, further comprising one or more virtual trader characters able to trade with said products.

82. An electronic game according to claim 81, wherein said virtual trader characters are indistinguishable from said player characters.
